(19) United States
(12) Patent Application Publication
(10) Pub. No.: US 2006/0014641 A1
(43) Pub. Date: Jan. 19, 2006

(54) Pathogen control with an oxalate (oxalic acid)

(76) Inventor: Ousama M. Zaghmout, Lorton, VA (US)

Correspondence Address: Dr. O. M. (Sam) Zaghmout, 8509 Kernon Ct, Lorton, VA, 22079, US

(21) Appl. No.: 11/179,674

(22) Filed: Jul. 13, 2005

Related U.S. Application Data
(60) Provisional application No. 60/587,080, filed on Jul. 13, 2004.

(51) Int. Cl. A01N 63/00; A01N 37/00; A01N 43/16

(52) U.S. Cl. 504/117; 514/460; 514/574

(57) ABSTRACT

This invention relates to a method of controlling pathogens, by use of oxalate-producing enzyme, alone or in combination with toxic protein may be applied directly to the plant or produced thereon by microorganisms or by genetically modifying the plant to produce the enzyme, and to genes, microorganisms, and plants useful in that method. In one aspect this invention relates to a method of controlling insects, including lepidopterans and boll weevils, by use of oxalate-producing enzyme, alone or in combination with a crystal protein from Bacillus thuringiensis or cholesterol oxidase which may be applied directly to the plant or produced thereon by microorganisms or by genetically modifying the plant to produce the enzyme, and to genes, microorganisms, and plants useful in that method.

### CROSS REFERENCE TO RELATED APPLICATIONS

This application claims the benefit of Patent Provisional application Ser. No. 60/587,080, filed Jul. 13, 2004 which claims the benefit of Patent Provisional application Ser. No. 60/561,897, filed Apr. 14, 2004 and Patent Provisional Application Ser. No. 60/564,207, filed Apr. 22, 2004 by the present inventor of this application. The entire content of these patent provisional applications are incorporated herein by a reference.

### FEDERALLY SPONSORED RESEARCH

Not Applicable

### SEQUENCE LISTING OR PROGRAM

Not Applicable

### FIELD OF THE INVENTION

This invention relates to a method of controlling pathogens, by use of oxalate-producing enzyme, alone or in combination with toxic protein may be applied directly to the plant or produced thereon by microorganisms or by genetically modifying the plant to produce the enzyme, and to genes, microorganisms, and plants useful in that method. In one aspect this invention relates to a method of controlling insects, including lepidopterans and boll weevils, by use of oxalate-producing enzyme, alone or in combination with a crystal protein from Bacillus thuringiensis or cholesterol oxidase which may be applied directly to the plant or produced thereon by microorganisms or by genetically modifying the plant to produce the enzyme, and to genes, microorganisms, and plants useful in that method.

### BACKGROUND OF THE INVENTION

The information provided below is not admitted to be prior art to the present invention, but is provided solely to assist the understanding of the reader.

The introduction of synthetic organic pesticides following World War II brought inestimable benefits to humanity and agricultural economic profitability. The widescale deployment of DDT resulted in the complete riddance, from entire countries, of serious public pests such as malaria mosquitoes. The use of DDT, other organochlorines, and, later, organophosphorus and carbamate materials was enthusiastically adopted into control programs despite occasional warnings about the hazard of unilateral approaches to pest control.

The development of new pesticides and the increasing amounts of pesticides used for pest control are closely correlated with the development of pest resistance to chemicals. The number of pesticide resistant species has greatly increased since the adoption of DDT in 1948. As a result, by the 1980s, the number of reports of pesticide resistance for arthropod pests was listed as 281, for plant pathogens 67, and for weeds 17. These numbers have steadily increased to the present day. Thus, the need for biological control agents, especially those with broadbase activity is especially important.

Problems with pesticide use:
intensive and prolonged use creates a high selection pressure against pests. As such, insect species may rapidly evolve resistance and the pesticides become useless.
secondary outbreaks—pests come back much stronger than the original infestation, due increased resistance.
environmental effects—pollution and effects on non-target species

In agricultural biotechnology, insect resistance, is a prime research area that has the potential to greatly improve agricultural productivity. Other agronomic traits to which biotechnology is being applied include viral, bacterial, and fungal resistance, herbicide tolerance, and stress tolerance.

Plants that have been transformed to produce a protein which confers upon expression resistance against insects (e.g., Bt protein) include potatoes, cotton, and corn, broccoli, tobacco, sweet potato, tomato, rice, rutabaga, soybean, walnut, poplar, larch, and apple and many other plant species. This is important in the light of the fact that some insects such as Colorado potato beetle is very resistant to all classes of classical pesticides. The benefits of the transgenic potato plants that express Bt protein that it provides excellent larvae control—there are essentially no survivors—and it also inhibits reproduction in the adult beetles. Similar benefits were obtained against European corn borer in corn and most lepidopterous insects and the boll weevil in cotton.

Cotton is one of the most heavily treated (with insecticides) crops in the U.S. The pests are mostly lepidopterous insects and the boll weevil. With transgenic cotton that express Bt protein, the larvae die before they reach the 2nd instar. To produce Bt cotton, the Bt gene is developed and introduced into a cotton plant. The lines with the best resistance are identified. This sometimes takes hundreds or thousands of transformants to get effective expression levels with appropriate and acceptable agronomics. With a plant like cotton, an extensive backcrossing program is necessary to get high yielding cotton lines of interest. There is also lots of regulatory input. In the field the transgenic cotton plant provides excellent bollworm and budworm control—equivalent to or better than currrent chemical insecticide programs. The transgenic cotton also provides yields equivalent to the best insecticide treatments, and sometimes better.

According to experts at the National Cotton Council of America (NCCA) it has been reported that Helicoverpa armigera (Cotton Bollworm) have developed resistance to Bt. The study suggests that populations of H. armigera were resistant to both Bt and transgenic cotton expressing the Bt toxin. According to NCCA: “The risk of development of resistance in Bt cotton crops is probably greater than that for Bt pesticide formulations due to continuous and extensive expression of the delta-endotoxin in the plant tissues (Report of an Expert Panel on Biotechnology in Cotton—International Cotton Advisory Committee—November 2000). Therefore, new strategies are needed to maximize the durability and utility of GE (genetically engineered) cotton and other GE plant species. In that respect, there is a need for additional proteins which control insects for which B.t. provides control in order to manage any development of resistance in the population. It is therefore an object of the present invention to provide proteins capable of controlling insects, such as boll weevil and lepidopterans, and genes useful in producing such proteins. It is a further object of the present invention to provide genetic constructs for and methods of inserting such genetic material into microorganisms and plant cells. It is another object of the present invention to provide transformed microorganisms and plants containing such genetic material.

Thus, there is a long-felt but unfulfilled need for a novel method which would permit one to effectively work out a solution for many of these problems. Several advantages of the present invention are discussed below, but numerous others will be apparent to one of ordinary skill in the arts.

### OBJECTS AND ADVANTAGES OF THE INVENTION

Before the subject invention is described further, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an” and “the” include plural reference unless the context clearly dictates otherwise. Unless defined otherwise, all technical and scientific terms used herein have the same meaning as commonly understood to one of ordinary skill in the art to which this invention belongs.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the preferred methods, devices and materials are now described.

All publications mentioned herein are incorporated herein by reference for the purpose of describing and disclosing the subject components of the invention that are described in the publications, which components might be used in connection with the presently described invention.

The information provided below is not admitted to be prior art to the present invention, but is provided solely to assist the understanding of the reader.

The details of one or more embodiments of the invention are set forth in the accompanying drawings and the description below. Other features, objects, and advantages of the invention will be apparent from the description and drawings, and from the claims.

The present invention concerns a method for combating the attack and spread of pathogens in plants, which method comprises combining a chemical and genetic means to control pathogens wherein the chemical is an oxalate.

The present invention concerns a method for combating the attack and spread of insect in plants, which method comprises combining a chemical and genetic means to control insect pathogens wherein the chemical is an oxalate.

The present invention concerns a method for combating the attack and spread of a fungus in plants, which method comprises combining a chemical and genetic means to control a fungus pathogens wherein the chemical is an oxalate.

The present invention concerns a method for combating the attack and spread of a nematode in plants, which method comprises combining a chemical and genetic means to control a nematode pathogens wherein the chemical is an oxalate.

It is a primary object of the present invention to provide a composition which contains an oxalate for application to various plant life including lawns, plants, and botancials, wherein the oxalate may be added alone, as a mixture in a composition, or as part of a composition.

It is a primary object of the present invention to provide a chemical composition which contains an oxalate for application to various plant life including lawns, plants, and botanicals, wherein the oxalate may be added alone, as a mixture in a chemical composition, or as part of a chemical composition.

It is a primary object of the present invention to provide an insecticide composition which contains an oxalate for application to various plant life including lawns, plants, and botancials, wherein the oxalate may be added alone, as a mixture in a composition, or as part of a composition.

It is a primary object of the present invention to provide fungicide composition which contains an oxalate for application to various plant life including lawns, plants, and botancials, wherein the oxalate may be added alone, as a mixture in a fungicide composition, or as part of a fungicide composition.

It is a primary object of the present invention to provide a nematicide composition which contains an oxalate for application to various plant life including lawns, plants, and botancials, wherein the oxalate may be added alone, as a mixture in a nematicide composition, or as part of a composition.

It is a primary object of the present invention to provide a fertilizing composition which contains an oxalate for application to various plant life including lawns, plants, and botancials, wherein the oxalate may be added alone, as a mixture in a fertilizing composition, or as part of a fertilizing composition.

It is a primary object of the present invention to provide a herbicide composition which contains an oxalate for application to various plant life including lawns, plants, and botancials, wherein the oxalate may be added alone, as a mixture in a fertilizing composition, or as part of a herbicide composition.

It is a primary object of the present invention to provide a method of controlling insect infestation of plants comprising providing an oxalate-generating enzyme and a Bacillus thuringiensis protein in an insecticidally effective amount for ingestion by the insect A method of controlling insect infestation of plants comprising providing an oxalate-generating enzyme and a CrylA Bacillus thuringiensis protein in an insecticidally effective amount for ingestion by the insect where the insect is identified as a lepidopteran.

It is a primary object of the present invention to provide a method of controlling insect infestation of plants comprising providing an oxalate-generating enzyme and a Bacillus thuringiensis protein in an insecticidally effective amount for ingestion by the insect where the insect is identified as a lepidopteran. In one aspect of the invention that the insect is in a larval stage. In one aspect of this invention, the CryIA is CryIA(c) or CryIA(b). In one aspect of this invention, the insect is tobacco budworm, beet armyworm, European corn borer, black cutworm or fall armyworm, cotton bollworm or corn earworm. In one aspect of this invention, the insecticidally effective amount is between about 8 and about 20 ppm.

It is a primary object of the present invention to provide a recombinant expression vector comprising nucleic acid sequences encoding and oxalate genetrating enzyme and a CryIA protein or a 3-hydroxysteroid oxidase, each sequence operatively linked to a promoter to express separately or in tandem said nucleic acid sequences to produce said oxalate and CryIA protein or said oxalate and 3-hydroxysteroid in a plant cell. The vector wherein the plant cell is identified as a cotton cell.

It is a primary object of the present invention to provide a method of producing a genetically transformed plant which produces an insecticidally effective amount of an oxalate and a CryIA protein or oxalate and a 3-hydroxysteroid oxidase, comprising inserting into the genome of a plant cell a recombinant vector comprising:
a) a sequence encoding an oxalat-generating enzyme;
b) a sequence encoding a CryIA protein or 3-hydroxysteroid oxidase and,
c) at least one promoter that functions in a plant cell which promoter is heterologous with respect to said coding sequences operatively linked to effect expression of said coding sequences to produce the oxalate and CrylA protein or the eoxalate and the 3-hydroxysteroid oxidase in an insecticidally effective amount in a genetically transformed plant obtained from the plant cell. In one aspect of this invention, the CryIA protein is identified as a CryIA(b) protein and the CryIA protein is identified as a CryIA(c) protein.

In one aspect of this invention the plant is a cotton plant. The plants and the seeds are also encompassed by this invention. These and other objects and advantages of the present invention will be more readily apparent with reference to the following detailed description.

In one aspect of the invention, the oxalate can be added as emulsifiable concentrates, coatable pastes, directly sprayable or dilutable solutions, dilute emulsions, wettable powders, soluble powders, dusts, granulates or microcapsules. Such formulations are described, for example, in WO 97/34485, pages 9 to 13. The formulations are prepared in known manner, conveniently by homogeneously mixing and/or grinding the active ingredients with liquid or solid formulation assistants, typically solvents or solid carriers. Surface-active compounds (surfactants) may additionally be used for preparing the formulations. Suitable solvents and solid carriers for this purpose are also described in said WO 97/34485, page 6. Suitable surface-active compounds are nonionic, cationic and/or anionic surfactants and surfactant mixtures having good emulsifying, dispersing and wetting properties. Examples of suitable anionic, nonionic, and cationic surfactants are listed for example in said WO 97/34485, pages 7 to 8. Also the surfactants customarily for the art of formulation and described, inter alia, in “Mc Cutcheon's Detergents and Emulsifiers Annual” MC Publishing Corp., Ridgewood N.J., 1981, Stache, H., “Tensid-Taschenbuch” (Handbook of Surfactants), Carl Hanser Verlag, Munich/Vienna, 1981, and M. and J. Ash, “Encyclopedia of Surfactants”, Vol I-III, Chemical Publishing Co., New York, 1980-81 are suitable for manufacture of the compositions according to the invention.

It is a primary object of the present invention to provide a composition which comprises, in variable quantities, a pesticidal effective amount of an oxalate.

It is a primary object of the present invention to provide a pesticidal composition which comprises, in variable quantities, a pesticidal effective amount of an oxalate and an additional pesticidally active compound.

It is a primary object of the present invention to provide a pesticidal composition which comprises, in variable quantities, an oxalate and a pesticidally active compound in free form or in the form of an agrochemically acceptable salt thereof.

It is a primary object of the present invention to provide a pesticidal composition which comprises, in variable quantities, an oxalate and a pesticidally active compound in free form or in the form of an agrochemically acceptable salt thereof, and at least one auxiliary or carrier material.

It is a primary object of the present invention to provide a method of controlling pests, which comprises applying a composition as described to the pests or to their environment.

It is a primary object of the present invention to provide a fertilizing composition which comprises, in variable quantities, an oxalate alone or in combination with a compound in free form or in the form of an agrochemically acceptable salt thereof.

It is a primary object of the present invention to provide a selectively herbicidal composition which, in addition to comprising formulation adjuvants, comprises as active ingredient a mixture of a) a herbicidally effective amount and b) an amount, effective oxalate.

It is a primary object of the present invention to provide a method of controlling pests in crops of transgenic plants, where a pesticidal composition comprising an oxalate, in free form or in agrochemically useful salt form and at least one auxiliary or suitable carrier material, is applied to the pests or their environment, wherein the oxalate compound produces synergistic results with said transgenic plants. The methods and products of this invention are also applicable to not transformed plants or non transgenic plants.

It is a primary object of the present invention to provide a method where the transgenic plant is treated. Another primary object of the present invention to provide a method of the invention where the propagation material of the transgenic plant is treated.

It is a primary object of the present invention to provide a method for introducing and/or improving plant resistance to attack and/or spread of a pathogen, said method comprising applying at least one compound to a plant or plant part, wherein said compound enhances said plant resistance to a pathogen wherein said compound is an oxalate.

It is a primary object of the present invention to provide a method for introducing and/or improving plant resistance to attack and/or spread of a pathogen, said method comprising applying at least one compound to a plant or plant part, wherein said compound synergistically enhances said plant resistance to a pathogen wherein said compound is an oxalate.

It is a primary object of the present invention to provide a method for introducing and/or improving plant resistance to attack and/or spread of a pathogen, said method comprising applying at least one compound to a plant or plant part genetically modified to express at least one agent able to trigger a hypersensitive response in a plant, wherein said compound synergistically enhances said plant resistance wherein said compound is an oxalate.

It is a primary object of the present invention to provide a pesticidal composition for treating infectious or pathogenic pest in a plant comprising:

a pesticidal composition including an effective amount of at least one effective pesticidal form of oxalate and at least one pesticide, wherein said effective amount is a lethal dosage of oxalate and wherein said pesticide composition is adapted to be administered to a plant on a periodic basis in a lethal dosage to a pest. The pesticidal composition as recited in the invention, wherein said effective pesticidal form of at least one of oxalate is selected from the group of oxalic acid in a free acid, ester, lactone and salt form. The pesticidal composition as recited in this invention, wherein said effective pesticidal form of oxalate is selected from the group of fungi, natural foods, for processed foods, beverages, liquids, and juices, containing at least one of oxalic acid and oxalate. The pesticidal composition as recited in this invention, wherein the composition is at least a therapeutic quantity of oxalate from a natural source. The pesticidal composition as recited in this invention, wherein the said composition is oxalic acid dihydrate and the at least one carrier and/or diluent. The pesticidal composition as recited in the invention, wherein said at least one of carrier and/or diluent. It is a primary object of the present invention to provide a method of producing the therapeutic composition as recited in the invention comprising the steps of mixing a dilute concentration of at least one therapeutically effective form of oxalate with a solvent. The method as recited in recited in the invention, wherein said therapeutically effective biocidal form of at least one of oxalic acid and oxalate is selected from the group of oxalic acid in a free acid, ester, lactone or salt form.

It is a primary object of the present invention to provide a method for treating infectious or pathogenic microbial disease, in a plant, comprising the steps of adding effective biocidal form of oxalate, wherein the plant is a transgenic or not transgenic.

It is a primary object of the present invention to provide a method for treating infectious or pathogenic microbial, bacterial, or viral wherein the method comprises the use of an oxalic acid or one or more of its derivatives. It is a primary object of the present invention to provide a veterinary method for treating infectious or pathogenic microbial, bacterial, or viral wherein the method comprises the use of an oxalic acid or one or more of its derivatives.

In aspect one the invention, the oxalate with or without pesticide is used to control from a parasite, insect, fungi, worm or mite infestation.

In aspect one the invention, the oxalate with or without pesticide is applied to a surface of the foliage of the plant.

In aspect one the invention, the oxalate with or without pesticide is applied to substantially all surfaces of the plant foliage.

In aspect one the invention, the oxalate with or without pesticide is applied by a spray technique.

In aspect one the invention, the oxalate with or without pesticide is applied to the plant at a rate of 10-300 ml per m2.

In aspect one the invention, the oxalate with or without pesticide is applied at a rate of 30-50 ml per m2.

In aspect one the invention, the oxalate with or without pesticide is applied to the plant in more than one application.

In aspect one the invention, the oxalate with or without pesticide is applied according to different stages of plant growth and disease progression.

In aspect one the invention, the oxalate with or without pesticide is applied in three treatment stages identified as pre-infection, maintenance and post-infection treatments.

In aspect one the invention, the oxalate with or without pesticide is applied in the pre-infection treatment at intervals of 1 to 10 days.

In aspect one the invention, the oxalate with or without pesticide is applied twice during the pre-infection treatment at about a 4-day interval.

In aspect one the invention, the maintenance treatment is applied 2 to 10 weeks after the pre-infection treatment.

In aspect one the invention, the maintenance treatment is applied 4-5 weeks after the pre-infection treatment and optionally reapplied at 2 to 8 week intervals or 4-5 week intervals.

In aspect one the invention, a first post-infection treatment is applied upon the appearance of signs of pest infection. In a more preferred part of the invention, a further post-infection treatment is applied. In a most preferred part of the invention, the further post-infection treatment is carried out 3 to 6 weeks after the first post-infection treatment.

In amost preferred part of the invention, the further post-infection treatment is carried out 4 to S weeks after the first post-infection treatment. In amost preferred part of this invention, the two pre-infection treatments are carried out at an interval of 4 days, followed by a first maintenance treatment 4 to 5 weeks after the last pre-infection treatment, and a further maintenance treatment 4 to 5 weeks after the first maintenance treatment.

### SUMMARY OF THE INVENTION

The present invention relates to a method of insect control for plants. This method involves applying an oxalate (oxalic acid) to plants or plant seeds under conditions effective to control insects on the plants or plants grown from the plant seeds.

As an alternative to applying an oxalate to plants or plant seeds in order to control insects on plants or plants grown from the seeds, transgenic plants or plant seeds can be utilized. When utilizing transgenic plants, this involves providing a transgenic plant transformed with a DNA molecule encoding polypeptide or protein that can mediates the production of oxalate and growing the plant under conditions effective to permit that DNA molecule to control insects. Alternatively, a transgenic plant seed transformed with a DNA molecule encoding polypeptide or protein that mediates the production of oxalate (e.g., oxaloacetate hydrolase—not limited to this example) can be provided and planted in soil. A plant is then propagated from the planted seed under conditions effective to control insects. Genes which encode proteins that help in increasing the production of oxalic acid such as, but not limited to, isocitrate lyase (EC 4.1.3.1), together with oxaloacetase (EC 3.7.1.1), malate dehydrogenase (EC 1.1.1.37), lactate dehydrogenase, gylcolate oxidase, oxaloacetate acetylhydrolase are also part of this invention.

As an alternative to applying an oxalate to plants or plant seeds in order to control insects on plants or plants grown from the seeds, transgenic plants or plant seeds can be utilized.

When utilizing transgenic plants, this involves providing a transgenic plant transformed with a DNA molecule encoding polypeptide or protein that can mediates the production of hydrogen peroxide (e.g., oxalic acid oxidase, glucose oxidase . . . ) and growing the plant under conditions effective to permit that DNA molecule to control insects. Alternatively, a transgenic plant seed transformed with a DNA molecule encoding polypeptide or protein that mediates the production of hydrogen peroxide can be provided and planted in soil. A plant is then propagated from the planted seed under conditions effective to control insects. In one aspect of the invention transgenic plants that express BT protein can be transformed with a DNA molecule encoding polypeptide or protein that mediates the production of hydrogen peroxide. In one aspect of the invention, transgenic plants that express BT protein may be crossed with a transgenic plants that express with a DNA molecule encoding polypeptide or protein that mediates the production of hydrogen peroxide. In one aspect of the invention, to further enhance the resistance to an insect, transgenic or non transgenic plant of the invention can be treated with a composition comprising an oxalate.

The present invention is directed to effecting any form of insect control for plants. For example, insect control according to the present invention encompasses preventing insects from contacting plants to which the oxalate has been applied, preventing direct insect damage to plants by feeding injury, causing insects to depart from such plants, killing insects proximate to such plants, interfering with insect larval feeding on such plants, preventing insects from colonizing host plants, preventing colonizing insects from releasing phytotoxins, etc. The present invention also prevents subsequent disease damage to plants resulting from insect infection. In that respect, oxalate will control lepidopteran insects and boll weevils. Oxlate is lethal to boll weevil larvae and will interrupt the reproductive cycle of adults. Oxalate will cause mortality and stunting of larvae of lepidopteran insects. The oxalate may be applied directly to plants or introduced in other ways such as through the application of plant-colonizing microorganisms or by the plants themselves, which have been transformed to produce the enzymes. Preparations of enzymes from several different sources are available from Sigma Chemical Company, St. Louis, Mo.

New genes that control the expression of oxalate been isolated and sequenced (e., lactate dehydrogenese (e.g., Evolutionary relationships of lactate dehydrogenases (LDHs) from mammals, birds, an amphibian, fish, barley, and bacteria: LDH cDNA sequences from Xenopus, pig, and rat. Proc Natl Acad Sci USA. 1994 Sep. 27; 91(20):9392-9396), glycolate oxidase, aldehyde dehydrogenase, oxaloacetate acetylhydrolyase . . . .). These new genes or genes from other known producers of oxalate may be inserted into a transformation vector cassette which is used to transform plant-colonizing microorganisms which when applied to plants express the genes producing an oxalate, thereby providing control of lepidopterans and boll weevil. Alternatively, genes which function in plants and encode the subject enzymes may be inserted into transformation vector cassettes which may be incorporated into the genome of the plant, which then protects itself from attack by expressing the gene and producing oxalate. Additionally, the plant may also be transformed to co-express other genes (e.g., B.t. genes) which express proteins for the control of other insects. Examples of plants transformed to express B.t. genes are disclosed in European Patent Publication No. 0385 962, [Fischhoff et al.], which is incorporated herein by reference. Other genes that control the expression of oxalate are parrt of the inventions. Examples of these genes which control the expression of oxalate, but not limited to are found in Homles. Journal of Nephrology. Vol. 11 S-1-1998/32-35, Microbiology. 1999. Vol. 145. 2569-2576, Keates et al. Oxalate biosynthesis from analogs of ascorbic acid in the pathogenic fungus Sclerotinia sclerotiorum. Abstarct Number: 151. American Society of Plant Physiology annual meeting.

In accomplishing the foregoing, there is provided, in accordance with one aspect of the present invention, a method of controlling insect infestation of plants by applying to the plant environment or plant seed an insecticidally effective amount of oxalate for ingestion by the insect, comprising providing oxalate for ingestion by the insect or by providing by admixture or in tandem an insecticidally effective amount of oxalate and a protein (e.g., cholesterol oxidase choM, a B.t crystal, CryIA(b) and CryIA(c)).

In accordance with another aspect of the present invention, there is provided a recombinant, double-stranded DNA molecule comprising in operative sequence:
a) a promoter which functions in plant cells to cause the production of an RNA sequence; and
b) a structural coding sequence that encodes an oxalate-producing enzyme;
c) a 3′ non-translated region which functions in plant cells to cause the addition of polyadenylate nucleotides to the 3′ end of the RNA sequence, wherein said promoter is heterologous with respect to the structural coding sequence and wherein said promoter is operatively linked with said structural coding sequence, which is in turn operably linked with said non-translated region.

In accordance with another aspect of the present invention, there is provided a method of producing genetically transformed plants which express an effective amount of oxalate, comprising the steps of:
a) inserting into the genome of a plant cell a recombinant, double-stranded DNA molecule comprising
(i) a promoter which functions in plant cells to cause the production of an RNA sequence;
(ii) a structural coding sequence that encodes for an oxalate-producing enzyme; and
(iii) a 3′ non-translated region which functions in said plant cells to cause the addition of polyadenylate nucleotides to the 3′ end of the RNA sequence, wherein said promoter is heterologous with respect to the structural coding sequence and wherein said promoter is operatively linked with said structural coding sequence, which is in turn operably linked with said non-translated region;
b) obtaining transformed plant cells; and
c) regenerating from the transformed plant cells genetically transformed plants which express an insecticidally effective amount of oxalate.

There is also provided, in accordance with another aspect of the present invention, bacterial and transformed plant cells that contain DNA comprised of the above-mentioned elements (i), (ii), and (iii).

Yet another aspect of the invention is the discovery of a synergistic effect of Bacillus thuringiensis proteins and oxalate against lepidopteran pests. More particularly, combinations of CryIA(c) or CryIA(b) and oxalate are more effective against lepidoptera larvae than the crystal protein administered alone. Yet another aspect of the invention is the discovery of a synergistic effect of Bacillus thuringiensis proteins and hydrogen peroxide against lepidopteran pests. In one aspect of this inventions transgenic plants that express Bacillus thuringiensis proteins are crossed with plants that express hydrogen peroxide generating enzymes such as oxalate oxidase, glucose oxidase and others that are know to one of ordinary skill in the art. In one aspect of this invention, plants or transgenic plants that express Bacillus thuringiensis proteins are transformed with a structural coding sequence that encodes for hydrogen-generating enzymes.

As a result, the present invention provides significant economic benefit to growers.

### DETAILED DESCRIPTION OF THE INVENTION

As used herein, the term “controlling insect infestation” means reducing the number of insects which cause reduced yield, either through mortality, retardation of larval development (stunting), or reduced reproductive efficiency.

As used herein, the term “structural coding sequence” means a DNA sequence which encodes for a polypeptide, which may be made by a cell following transcription of the DNA to mRNA, followed by translation to the desired polypeptide.

As used herein, the term “plant-colonizing microorganism” means a microorganism capable of colonizing a “plant environment” and expressing the oxalate in the plant environment such that the microorganisms can exist in a symbiotic or non-detrimental relationship with the plant. Examples of such plant-colonizing microorganisms are provided below.

As used herein, the term “plant environment” means the surface of the plant, e.g. leaf, stem, buds, stalk, floral parts, root surface, the “rhizosphere”, i.e. the soil which surrounds and may be influenced by the roots of the plant., and/or extracellular areas within the plant itself, i.e. the plant vasculature.

Oxalic acid is a strong acid, and is corrosive to tissue. Oxalic acid may combine with calcium, iron, sodium, magnesium, or potassium to form less soluble salts known as oxalates. When ingested, oxalic acid removes calcium from the blood. Kidney damage can be expected as the calcium is removed from the blood in the form of calcium oxalate.

The calcium oxalate then obstructs the kidney tubules.

The present invention relates to a method of insect control for plants. This method involves applying an oxalate in any form to all or part of a plant or a plant seed under conditions to control insects on plants or plants grown from the plant seed. Alternatively, the oxalate can be applied to plants such that seeds recovered from such plants are themselves effective to control insects.

As an alternative to applying an oxalate to plants or plant seeds in order to control insects on the plants or plants grown from the seeds, transgenic plants or plant seeds can be utilized. When utilizing transgenic plants, this involves providing a transgenic plant transformed with a DNA molecule encoding a polypeptide or protein which mediates oxalate production in a plant and growing the plant under conditions effective to permit that DNA molecule to control insects. Alternatively, a transgenic plant seed transformed with a DNA molecule encoding a polypeptide or protein that mediates oxalate production can be provided and planted in soil. A plant is then propagated from the planted seed under conditions effective to permit that DNA molecule to control insects.

The oxalate utilized in the present invention can correspond to oxalate derived from a wide variety of sources such as, but not limited to, plants and fungal pathogens as well as others. Examples of suitable fungal sources sources of oxalate Scleortinia.

The embodiment of the present invention where the oxalate is applied to the plant or plant seed can be carried out in a number of ways, including: 1) application of an oxalate; 2) application of a pathogen (e.g., fungus) which do not cause disease and are transformed with genes encoding a protein or a polypeptide which mediates the production of an oxalate. In addition, seeds in accordance with the present invention can be recovered from plants which have been treated with an oxalate in accordance with the present invention.

In one embodiment of the present invention, the oxalate can be isolated from their corresponding organisms and applied to plants or plant seeds.

In other embodiments of the present invention, the oxalate of the present invention can be applied to plants or plant seeds by applying a pathogen (e.g., fungus) containing genes encoding a protein which mediates the production of oxalate. Such pathogen must be capable of secreting or exporting the oxalate so that the oxalate can contact plant or plant seeds cells.

The method of the present invention can be utilized to treat a wide variety of plants or their seeds to control insects. Suitable plants include, but not limited to, dicots and monocots as well as gymenosperm. More particularly, useful crop plants can include: alfalfa, rice, wheat, barley, rye, cotton, sunflower, peanut, corn, potato, sweet potato, bean, pea, chicory, lettuce, endive, cabbage, brussel sprout, beet, parsnip, turnip, cauliflower, broccoli, turnip, radish, spinach, onion, garlic, eggplant, pepper, celery, carrot, squash, pumpkin, zucchini, cucumber, apple, pear, melon, citrus, strawberry, grape, raspberry, pineapple, soybean, tobacco, tomato, sorghum, and sugarcane. Examples of suitable ornamental plants, but not limited to, are roses, Arabidopsis thaliana, Saintpaulia, petunia, pelargonium, poinsettia, chrysanthemum, carnation, and zinnia.

The present invention is effective against a wide variety of insects. Example of these insects, but not limited to, are insects (Phylum Arthropoda, Class Insecta) also encompasses Phylum Mollusca (snails and slugs represented by the spotted garden slug, banded slug, marsh slug, and gray garden slug), Class Arachnida (mites), and Phylum Nematoda (roundworms or nematodes). The host range for some of these pests is extensive. For example, the European corn borer is a major pest of corn (dent and sweet corn) but also feeds on over 200 plants species including green, wax, and lima beans and edible soybeans, peppers, potato, and tomato plus many weed species. Additional insect larvae and adult feeding pests which feed on and damage a wide variety of vegetables and small fruits include the following: Vegetables—seed corn maggot, rice armyworm, alfalfa leafhopper, aster leafhopper, beet armyworm, cabbage looper, cabbage root maggot, Colorado potato beetle, corn earworm, cotton or melon aphid, diamondback moth, fall armyworm, flea beetles (various adult species feed on cabbage, mustard, and other crucifiers, cucumber, eggplant, tobacco, potato, melon, and spinach), green peach aphid, onion maggot, onion thrips, pepper maggot, pickleworm (melon worm), potato leafhopper, potato stem borer, potato and corn stalk borer, striped cucumber beetle, spotted cucumber beetle, northern and western corn root worm, thrips, tarnish plant bug, tobacco aphid, tomato pinworm, tomato mole cricket, and rootknot nematode; Small fruits—meadow spittlebug, strawberry bud weevil, strawberry root weevil, tarnish plant bug, and strawberry spider mites; Grapes—grape berry moth, grape cane gallmaker, climbing cutworms, grape leafhoppers (three species), and grape cane girdler. Collectively this group of insects and allied species represents the most economically important group of pests for vegetables, small fruit, cotton and grape production worldwide.

The present invention is effective against a wide variety of plant pathogens of economic importance include, but not limited to, the pathogens in the genera Agaricus, Alternaria, Anisogramma, Anthracoidea, Antrodia, Apiognomonia, Apiosporina, Armillaria, Ascochyta, Aspergillus, Bipolaris, Bjerkandera, Botryosphaeria, Botrytis, Ceratobasidium, Ceratocystis, Cercospora, Cercosporidium, Cerotelium, Cerrena, Chondrostereum, Chryphonectria, Chrysomyxa, Cladosporium, Claviceps, Cochliobolus, Coleosporium, Colletotrichium, Colletotrichum, Corticium, Corynespora, Cronartium, Cryphonectria, Cryptosphaeria, Cyathus, Cymadothea, Cytospora, Daedaleopsis, Diaporthe, Didymella, Diplocarpon, Diplodia, Discohainesia, Discula, Dothistroma, Drechslera, Echinodontium, Elsinoe, Endocronartium, Endothia, Entyloma, Epichloe, Erysiphe, Exobasidium, Exserohilum, Fomes, Fomitopsis, Fusarium, Gaeumannomyces, Ganoderma, Gibberella, Gloeocercospora, Gloeophyllum, Gloeoporus, Glomerella, Gnomoniella, Guignardia, Gymnosporangium, Helminthosporium, Herpotrichia, Heterobasidion, Hirschioporus, Hypodermella, Inonotus, Irpex, Kabatiella, Kabatina, Laetiporus, Laetisaria, Lasiodiplodia, Laxitextum, Leptographium, Leptosphaeria, Leptosphaerulina, Leucytospora, Linospora, Lophodermella, Lophodermium, Macrophomina, Magnaporthe, Marssonina, Melampsora, Melampsorella, Meria, Microdochium, Microsphaera, Monilinia, Monochaetia, Morchella, Mycosphaerella, Myrothecium, Nectria, Nigrospora, Ophiosphaerella, Ophiostoma, Penicillium, Perenniporia, Peridermium, Pestalotia, Phaeocryptopus, Phaeolus, Phakopsora, Phellinus, Phialophora, Phoma, Phomopsis, Phragmidium, Phyllachora, Phyllactinia, Phyllosticta, Phymatotrichopsis, Pleospora, Podosphaera, Pseudopeziza, Pseudoseptoria, Puccinia, Pucciniastrum, Pyricularia, Rhabdocline, Rhizoctonia, Rhizopus, Rhizosphaera, Rhynchosporium, Rhytisma, Schizophyllum, Schizopora, Scirrhia, Sclerotinia, Sclerotium, Scytinostroma, Septoria, Setosphaera, Sirococcus, Spaerotheca, Sphaeropsis, Sphaerotheca, Sporisorium, Stagonospora, Stemphylium, Stenocarpella, Stereum, Taphrina, Thielaviopsis, Tilletia, Trametes, Tranzschelia, Trichoderma, Tubakia, Typhula, Uncinula, Urocystis, Uromyces, Ustilago, Valsa, Venturia, Verticillium, Xylaria, and others. Related organisms in the classification, oomycetes, that include the genera Albugo, Aphanomyces, Bremia, Peronospora, Phytophthora, Plasmodiophora, Plasmopara, Pseudoperonospora, Pythium, Sclerophthora, and others are also significant plant pathogens and are sometimes classified along with the true fungi. Human diseases that are caused by filamentous fungi include life-threatening lung and disseminated diseases, often a result of infections by Aspergillus fumigatus. Other fungal diseases in animals are caused by fungi in the genera, Fusarium, Blastomyces, Microsporum, Trichophyton, Epidermophyton, Candida, Histoplamsa, Pneumocystis, Cryptococcus, other Aspergilli, and others.

The present invention is effective against a wide variety of nematodes, bacteria, virus and other pathogen that are know to those of ordinary skill in the art. Some of these pathogens are listed in plant pathogen book that was authord by Agrios (George N. Agrios, University of Florida, Plant Pathology. Academic Press) where its entire content is incorporated herein by a reference.

The method of the present invention involving application of the oxalate can be carried out through a variety of procedures when all or part of the plant is treated, including leaves, stems, roots, etc. This may (but need not) involve infiltration of the oxalate into the plant. Suitable application methods include high or low pressure spraying, injection, dusting, and leaf abrasion proximate to when oxalate application takes place. When treating plant seeds, in accordance with the application embodiment of the present invention, the oxalate can be applied by low or high pressure spraying, coating, immersion, dusting, or injection. Other suitable application procedures can be envisioned by those skilled in the art provided they are able to effect contact of the oxalate with cells of the plant or plant seed. Once treated with the oxalate of the present invention, the seeds can be planted in natural or artificial soil and cultivated using conventional procedures to produce plants. After plants have been propagated from seeds treated in accordance with the present invention, the plants may be treated with one or more applications of the oxalate to control a pathogen (e.g., insects) on the plants. Such propagated plants may, in turn, be useful in producing seeds or propagules (e.g., cuttings) that produce plants capable of insect control.

The oxalate can be applied to plants or plant seeds in accordance with the present invention alone or in a mixture with other materials. Alternatively, the oxalate can be applied separately to plants with other materials being applied at different times.

A composition suitable for treating plants or plant seeds in accordance with the application embodiment of the present invention contains an oxalate in a carrier. Suitable carriers include water, aqueous solutions, slurries, or dry powders.

Although not required, this composition may contain additional additives including fertilizer, insecticide, fungicide, nematacide, herbicide, and mixtures thereof.

Other suitable additives include buffering agents, wetting agents, coating agents, and abrading agents. These materials can be used to facilitate the process of the present invention. In addition, the oxalate can be applied to plant seeds with other conventional seed formulation and treatment materials, including clays and polysaccharides.

In the alternative embodiment of the present invention involving the use of transgenic plants and transgenic seeds, an oxalate needs not be applied topically to the plants or seeds. Instead, transgenic plants transformed with a DNA molecule encoding a polypeptide or protein which mediates oxalate production in a plant are produced according to procedures well known in the art, such as by biolistics or Agrobacterium mediated transformation. Examples of the gene that can be used in the transformation, but not limited to, are Glyoxylate reductase/hydroxypyruvate reductase (GRHPR), Alanine-glyoxylate aminotransferase, oxaloacetase (EC 3.7.1.1), malate dehydrogenase (EC 1.1.1.37), lactate dehydrogenase, gylcolate oxidase, oxaloacetate acetylhydrolase.

Once transgenic plants of this type are produced, the plants themselves can be cultivated in accordance with conventional procedure with the presence of the gene encoding the protein which mediates the oxalate production resulting in control of insects on the plant. Alternatively, transgenic seeds are recovered from the transgenic plants. These seeds can then be planted in the soil and cultivated using conventional procedures to produce transgenic plants. The transgenic plants are propagated from the planted transgenic seeds under conditions effective to control insects. While not wishing to be bound by theory, such growth enhancement may be RNA mediated or may result from expression of the polypeptide or protein which mediates oxalate production in a plant.

When transgenic plants and plant seeds are used in accordance with the present invention, they additionally can be treated with the same materials as are used to treat the plants and seeds to which an oxalate is applied. These other materials, including oxalate, can be applied to the transgenic plants and plant seeds by the above-noted procedures, including high or low pressure spraying, injection, coating, dusting, and immersion. Similarly, after plants have been propagated from the transgenic plant seeds, the plants may be treated with one or more applications of the oxalate to control insects. Such plants may also be treated with conventional plant treatment agents (e.g., insecticides, fertilizers, etc.). The transgenic plants of the present invention are useful in producing seeds or propagules (e.g., cuttings) from which plants capable of insect control would be produced.

The method of the present invention can be utilized with a pestiscide. Examples of these pesticide groups are listed herein. Members of these pesticide groups are also encompassed by this invention. Combination of oxalate with other pesticides that are not listed herein is also a part of this inventions.

| | | |
|---|---|---|
| Acaricides | Algicides | Antifeedants |
| Avicides | Bactericides | Bird repellents |
| Chemosterilants | Fungicides | Herbicide safeners |
| Herbicides | Insect attractants | Insect repellents |
| Insecticides | Mammal repellents | Mating disrupters |
| Molluscicides | Nematicides | Plant activators |
| Plant growth regulators | Rodenticides | Synergists |
| Virucides | | |

According to one of the embodiment of this invention, oxalate may be used alone or in combination with in one or more of the chemical classes:
acylalanine fungicides
acylamino acid fungicides
aliphatic amide organothiophosphate insecticides
aliphatic nitrogen fungicides
aliphatic organothiophosphate insecticides
amide fungicides
amide herbicides
anilide fungicides
anilide herbicides
antiauxins
antibiotic acaricides
antibiotic fungicides
antibiotic herbicides
antibiotic insecticides
antibiotic nematicides
aromatic acid herbicides
aromatic fungicides
arsenical herbicides
arsenical insecticides
arylalanine herbicides
aryloxyphenoxypropionic herbicides
auxins
avermectin acaricides
avermectin insecticides
benzamide fungicides
benzanilide fungicides
benzimidazole fungicides
benzimidazole precursor fungicides
benzimidazolylcarbamate fungicides
benzofuranyl alkylsulfonate herbicides
benzofuranyl methylcarbamate insecticides
benzoic acid herbicides
benzothiazole fungicides
benzothiopyran organothiophosphate insecticides
benzotriazine organothiophosphate insecticides
benzoylcyclohexanedione herbicides
bipyridylium herbicides
botanical insecticides
botanical rodenticides
bridged diphenyl acaricides
bridged diphenyl fungicides
carbamate acaricides
carbamate fungicides
carbamate herbicides
carbamate insecticides
carbamate nematicides
carbanilate fungicides
carbanilate herbicides
chitin synthesis inhibitors
chloroacetanilide herbicides
chloronicotinyl insecticides
chloropyridine herbicides see http://www.alanwood.net/pesticides/class_herbicides.html—
pyridine_herbicides
chlorotriazine herbicides
conazole fungicides
copper fungicides
coumarin rodenticides
cyclic dithiocarbamate fungicides
cyclodiene insecticides
cyclohexene oxime herbicides
cyclopropylisoxazole herbicides
cytokinins
defoliants
diacylhydrazine insecticides
dicarboximide fungicides
dicarboximide herbicides
dichlorophenyl dicarboximide fungicides
dimethylcarbamate insecticides
dinitroaniline herbicides
dinitrophenol acaricides
dinitrophenol fungicides
dinitrophenol herbicides
dinitrophenol insecticides
diphenyl ether herbicides
dithiocarbamate fungicides
dithiocarbamate herbicides
ethylene releasers
fluorine insecticides
formamidine acaricides
formamidine insecticides
fumigant insecticides
furamide fungicides
furanilide fungicides
gibberellins
growth inhibitors
growth retardants
growth stimulators
halogenated aliphatic herbicides
heterocyclic organothiophosphate insecticides
imidazole fungicides
imidazolinone herbicides
indandione rodenticides
inorganic fungicides
inorganic herbicides
inorganic insecticides
inorganic mercury fungicides
inorganic rodenticides
insect growth regulators
isoindole organothiophosphate insecticides
isoxazole organothiophosphate insecticides
juvenile hormone mimics
juvenile hormones
macrocyclic lactone acaricides
macrocyclic lactone insecticides
mercury fungicides
methoxytriazine herbicides
methylthiotriazine herbicides
milbemycin acaricides
milbemycin insecticides
mite growth regulators
morphactins
morpholine fungicides
moulting hormone agonists
moulting hormones
moulting inhibitors
nereistoxin analogue insecticides
nicotinoid insecticides
nitrile herbicides
nitroguanidine insecticides
nitromethylene insecticides
nitrophenyl ether herbicides
organochlorine acaricides
organochlorine insecticides
organochlorine rodenticides
organomercury fungicides
organophosphate acaricides
organophosphate insecticides
organophosphate nematicides
organophosphorus acaricides
organophosphorus fungicides
organophosphorus herbicides
organophosphorus insecticides
organophosphorus nematicides
organophosphorus rodenticides
organothiophosphate acaricides
organothiophosphate insecticides
organothiophosphate nematicides
organotin acaricides
organotin fungicides
oxadiazine insecticides
oxathiin fungicides
oxazole fungicides
oxime carbamate acaricides
oxime carbamate insecticides
oxime carbamate nematicides
oxime organothiophosphate insecticides
phenoxy herbicides
phenoxyacetic herbicides
phenoxybutyric herbicides
phenoxypropionic herbicides
phenyl ethylphosphonothioate insecticides
phenyl methylcarbamate insecticides
phenyl organothiophosphate insecticides
phenyl phenylphosphonothioate insecticides
phenylenediamine herbicides
phenylsulfamide acaricides
phenylsulfamide fungicides
phenylurea herbicides
phosphonate acaricides
phosphonate insecticides
phosphonothioate insecticides
phosphoramidate insecticides
phosphoramidothioate acaricides
phosphoramidothioate insecticides
phosphorodiamide acaricides
phosphorodiamide insecticides
phthalic acid herbicides
phthalimide acaricides
phthalimide fungides
phthalimide insecticides
picolinic acid herbicides
polymeric dithiocarbamate fungicides
polysulfide fungicides
precocenes
pyrazole acaricides
pyrazole fungicides
pyrazole insecticides
pyrazolopyrimidine organothiophosphate insecticides
pyrazolyloxyacetophenone herbicides
pyrazolylphenyl herbicides
pyrethroid acaricides
pyrethroid ester acaricides
pyrethroid ester insecticides
pyrethroid ether acaricides
pyrethroid ether insecticides
pyrethroid insecticides
pyridazine herbicides
pyridazinone herbicides
pyridine fungicides
pyridine herbicides
pyridine organothiophosphate insecticides
pyridylmethylamine insecticides
pyrimidinamine acaricides
pyrimidinamine insecticides
pyrimidinamine rodenticides
pyrimidine fungicides
pyrimidine organothiophosphate insecticides
pyrimidinediamine herbicides
pyrimidinyloxybenzoic acid herbicides
pyrimidinylsulfonylurea herbicides
pyrimidinylthiobenzoic acid herbicides
pyrrole acaricides
pyrrole fungicides
pyrrole insecticides
quaternary ammonium herbicides
quinoline fungicides
quinolinecarboxylic acid herbicides
quinone fungicides
quinoxaline acaricides
quinoxaline fungicides
quinoxaline organothiophosphate insecticides
strobilurin fungicides
sulfite ester acaricides
sulfonanilide fungicides
sulfonanilide herbicides
sulfonylurea herbicides
tetrazine acaricides
tetronic acid acaricides
tetronic acid insecticides
thiadiazole organothiophosphate insecticides
thiadiazolylurea herbicides
thiazole fungicides
thiocarbamate acaricides
thiocarbamate fungicides
thiocarbamate herbicides
thiocarbonate herbicides
thiophene fungicides
thiourea acaricides
thiourea herbicides
thiourea rodenticides
triazine fungicides
triazine herbicides
triazinone herbicides
triazinylsulfonylurea herbicides
triazole fungicides
triazole herbicides
triazole organothiophosphate insecticides
triazolone herbicides
triazolopyrimidine herbicides
uracil herbicides
urea fungicides
urea herbicides
urea insecticides
urea rodenticides
valinamide fungicides
xylylalanine fungicides
   Examples of Acaricides:
antibiotic acaricides
nikkomycins
thuringiensin
   macrocyclic lactone acaricides
   tetranactin
      avermectin acaricides
      abamectin
      doramectin
      eprinomectin
      ivermectin
      selamectin
      milbemycin acaricides
      milbemectin
      milbemycin oxime
      moxidectin
   bridged diphenyl acaricides
   azobenzene
   benzoximate
   benzyl benzoate
   bromopropylate
   chlorbenside
   chlorfenethol
   chlorfenson
   chlorfensulphide
   chlorobenzilate
   chloropropylate
   DDT
   dicofol
   diphenyl sulfone
   dofenapyn
   fenson
   fentrifanil
   fluorbenside
   proclonol
   tetradifon
   tetrasul
   carbamate acaricides
   benomyl
   carbanolate carbaryl
   carbofuran
   methiocarb
   metolcarb
   promacyl
   propoxur
      oxime carbamate acaricides
      aldicarb
      butocarboxim
      oxamyl
      thiocarboxime
      thiofanox
   dinitrophenol acaricides
   binapacryl
   dinex
   dinobuton
   dinocap
   dinocap-4
   dinocap-6
   dinocton
   dinopenton
   dinosulfon
   dinoterbon
   DNOC
   formamidine acaricides
   amitraz
   chlordimeform
   chloromebuform
   formetanate
   formparanate
   mite growth regulators
   clofentezine
   diflovidazin
   dofenapyn
   fluazuron
   flubenzimine
   flucycloxuron
   flufenoxuron
   hexythiazox
   organochlorine acaricides
   bromocyclen
   cam phechlor
   DDT
   dienochlor
   endosulfan
   lindane
   organophosphorus acaricides
      organophosphate acaricides
      chlorfenvinphos
      crotoxyphos
      dichlorvos
      heptenophos
      mevinphos
      monocrotophos
      naled
      schradan
      TEPP
      tetrachlorvinphos
      organothiophosphate acaricides
      amidithion
      amiton
      azinphos-ethyl
      azinphos-methyl
      azothoate
      benoxafos
      bromophos
      bromophos-ethyl
      carbophenothion
      chlorpyrifos
      chlorthiophos
      coumaphos
      cyanthoate
      demeton
      demeton-O
      demeton-S
      demeton-methyl
      demeton-O-methyl demeton-S-methyl
      demeton-S-methylsulphon
      dialifos
      diazinon
      dimethoate
      dioxathion
      disulfoton
      endothion
      ethion
      ethoate-methyl
      formothion
      malathion
      mecarbam
      methacrifos
      omethoate
      oxydeprofos
      oxydisulfoton
      parathion
      phenkapton
      phorate
      phosalone
      phosmet
      phoxim
      pirimiphos-methyl prothidathion
      prothoate
      pyrimitate
      quinalphos
      quintiofos
      sophamide
      sulfotep
      thiometon
      triazophos
      trifenofos
      vamidothion
      phosphonate acaricides
      trichlorfon
      phosphoramidothioate acaricides
      isocarbophos
      methamidophos
      propetamphos
      phosphorodiamide acaricides
      dimefox
      mipafox
   organotin acaricides
   azocyclotin
   cyhexatin
   fenbutatin oxide
   phenylsulfamide acaricides
   dichlofluanid
   phthalimide acaricides
   dialifos
   phosmet
   pyrazole acaricides
   acetoprole
   fipronil
   tebufenpyrad
   vaniliprole
   pyrethroid acaricides
      pyrethroid ester acaricides
      acrinathrin
      bifenthrin
      cyhalothrin
      cypermethrin
      alpha-cypermethrin
      fenpropathrin
      fenvalerate
      flucythrinate
      flumethrin
      fluvalinate
      tau-fluvalinate
      permethrin
      pyrethroid ether acaricides
      halfenprox
   pyrimidinamine acaricides
   pyrimidifen
   pyrrole acaricides
   chlorfenapyr
   quinoxaline acaricides
   chinomethionat
   thioquinox
   sulfite ester acaricides
   propargite
   tetrazine acaricides
   clofentezine
   diflovidazin
   tetronic acid acaricides
   spirodiclofen
   thiocarbamate acaricides
   fenothiocarb
   thiourea acaricides
   chloromethiuron
   diafenthiuron
   unclassified acaricides
   acequinocyl
   amidoflumet
   arsenous oxide
   bifenazate
   closantel
   crotamiton
   disulfiram
   etoxazole
   fenazaflor
   fenazaquin
   fenpyroximate
   fluacrypyrim
   fluenetil
   mesulfen
   MNAF
   nifluridide
   pyridaben
   sulfiram
   sulfluramid
   sulfur
   triarathene
      Examples of Algicides
bethoxazin
copper sulfate
cybutryne
dichlone
dichlorophen
endothal
fentin
hydrated lime
nabam
quinoclamine
quinonamid
simazine
   Antifeedants
chlordimeform
fentin
guazatine
pymetrozine
   Avicides
4-aminopyridine
chloralose
endrin
fenthion
strychnine
   Examples of Avicides:

4-aminopyridine
chloralose
endrin
fenthion
strychnine
   Examples of Bactericides:
bronopol
copper hydroxide
cresol
dichlorophen
dipyrithione
dodicin
fenaminosulf
formaldehyde
hydrargaphen
8-hydroxyquinoline sulfate
kasugamycin
nitrapyrin
octhilinone
oxolinic acid
oxytetracycline
probenazole
streptomycin
tecloftalam
thiomersal
   Examples of Bird Repellents:
anthraquinone
chloralose
copper oxychloride
diazinon
guazatine
methiocarb
thiram
trimethacarb
ziram
   Chemosterilants
apholate
bisazir
busulfan
diflubenzuron
dimatif
hemel
hempa
metepa
methiotepa
methyl apholate
morzid
penfluron
tepa
thiohempa
thiotepa
tretamine
uredepa
   Fungicides
   aliphatic nitrogen fungicides
   butylamine
   cymoxanil
   dodicin
   dodine
   guazatine
   iminoctadine
   amide fungicides
   carpropamid
   chloraniformethan
   cyazofamid
   cyflufenamid
   diclocymet
   ethaboxam
   fenoxanil
   flumetover
   furametpyr
   penthiopyrad
   prochloraz
   quinazamid
   silthiofam
   triforine
      acylamino acid fungicides
      benalaxyl
      benalaxyl-M
      furalaxyl
      metalaxyl
      metalaxyl-M
      pefurazoate
      benzamide fungicides
      benzohydroxamic acid
      fluopicolide
      tioxymid
      trichlamide
      zarilamid
      zoxamide
      furamide fungicides
      cyclafuramid
      furmecyclox
      phenylsulfamide fungicides
      dichlofluanid
      tolylfluanid
      valinamide fungicides
      benthiavalicarb
      iprovalicarb
      anilide fungicides
      benalaxyl
      benalaxyl-M
      boscalid
      carboxin
      fenhexamid
      metalaxyl
      metalaxyl-M
      metsulfovax
      ofurace
      oxadixyl
      oxycarboxin
      pyracarbolid
      thifluzamide
      tiadinil
         benzanilide fungicides
         benodanil
         flutolanil
         mebenil
         mepronil
         salicylanilide
         tecloftalam
         furanilide fungicides
         fenfuram
         furalaxyl
         furcarbanil
         methfuroxam
         sulfonanilide fungicides
         flusulfamide
   antibiotic fungicides aureofungin
   blasticidin-S
   cycloheximide
   griseofulvin
   kasugamycin
   natamycin
   polyoxins
   polyoxorim
   streptomycin
   validamycin
      strobilurin fungicides
      azoxystrobin
      dimoxystrobin
      fluoxastrobin
      kresoxim-methyl
      metominostrobin
      orysastrobin
      picoxystrobin
      pyraclostrobin
      trifloxystrobin
   aromatic fungicides
   biphenyl
   chlorodinitronaphthalene
   chloroneb
   chlorothalonil
   cresol
   dicloran
   hexachlorobenzene
   pentachlorophenol
   quintozene
   sodium pentachlorophenoxide
   tecnazene
   benzimidazole fungicides
   benomyl
   carbendazim
   chlorfenazole
   cypendazole
   debacarb
   fuberidazole
   mecarbinzid
   rabenzazole
   thiabendazole
   benzimidazole precursor fungicides
   furophanate
   thiophanate
   thiophanate-methyl
   benzothiazole fungicides
   bentaluron
   chlobenthiazone
   TCMTB
   bridged diphenyl fungicides
   bithionol
   dichlorophen
   diphenylamine
   carbamate fungicides
   benthiavalicarb
   furophanate
   iprovalicarb
   propamocarb
   thiophanate
   thiophanate-methyl
      benzimidazolylcarbamate fungicides
      benomyl
      carbendazim
      cypendazole
      debacarb
      mecarbinzid
      carbanilate fungicides
      diethofencarb
   conazole fungicides
      conazole fungicides (imidazoles)
      climbazole
      clotrimazole
      imazalil
      oxpoconazole
      prochloraz
      triflumizole
      see also imidazole fungicides
      conazole fungicides (triazoles)
      azaconazole
      bromuconazole
      cyproconazole
      diclobutrazol
      difenoconazole
      diniconazole
      diniconazole-M
      epoxiconazole
      etaconazole fenbuconazole
      fluquinconazole
      flusilazole
      flutriafol
      furconazole
      furconazole-cis
      hexaconazole
      imibenconazole
      ipconazole
      metconazole
      myclobutanil
      penconazole
      propiconazole
      prothioconazole
      quinconazole
      simeconazole
      tebuconazole
      tetraconazole
      triadimefon
      triadimenol
      triticonazole
      uniconazole
      uniconazole-P
      see also triazole fungicides
   copper fungicides
   Bordeaux mixture
   Burgundy mixture
   Cheshunt mixture
   copper acetate
   copper carbonate, basic
   copper hydroxide
   copper naphthenate
   copper oleate
   copper oxychloride
   copper sulfate
   copper sulfate, basic
   copper zinc chromate
   cufraneb
   cuprobam
   cuprous oxide
   mancopper
   oxine copper
   dicarboximide fungicides
   famoxadone
   fluoroimide
      dichlorophenyl dicarboximide fungicides
      chlozolinate
      dichlozoline
      iprodione
      isovaledione
      myclozolin
      procymidone
      vinclozolin
      phthalimide fungicides
      captafol
      captan
      ditalimfos
      folpet
      thiochlorfenphim
   dinitrophenol fungicides
   binapacryl
   dinobuton
   dinocap
   dinocap-4
   dinocap-6
   dinocton
   dinopenton
   dinosulfon
   dinoterbon
   DNOC
   dithiocarbamate fungicides
   azithiram
   carbamorph
   cufraneb
   cuprobam
   disulfiram
   ferbam
   metam
   nabam
   tecoram
   thiram
   ziram
      cyclic dithiocarbamate fungicides
      dazomet
      etem
      milneb
      polymeric dithiocarbamate fungicides
      mancopper
      mancozeb
      maneb
      metiram
      polycarbamate
      propineb
      zineb imidazole fungicides
   cyazofamid
   fenamidone
   fenapanil
   glyodin
   iprodione
   isovaledione
   pefurazoate
   triazoxide
   see also conazole fungicides (imidazoles)
   inorganic fungicides
   potassium azide
   potassium thiocyanate
   sodium azide
   sulfur
   see also copper fungicides
   see also inorganic mercury fungicides
   mercury fungicides
      norganic mercury fungicides
      mercuric chloride
      mercuric oxide
      mercurous chloride
      organomercury fungicides
      (3-ethoxypropyl)mercury bromide
      ethylmercury acetate
      ethylmercury bromide
      ethylmercury chloride
      ethylmercury 2,3-dihydroxypropyl mercaptide
      ethylmercury phosphate
      N-(ethylmercury)-p-toluenesulphonanilide
      hydrargaphen
      2-methoxyethylmercury chloride
      methylmercury benzoate
      methylmercury dicyandiamide
      methylmercury pentachlorophenoxide
      8-phenylmercurioxyquinol ine
      phenylmercuriurea
      phenylmercury acetate
      phenylmercury chloride
      phenylmercury derivative of pyrocatechol
      phenylmercury nitrate
      phenylmercury salicylate
      thiomersal
      tolylmercury acetate
   morpholine fungicides
   aldimorph
   benzamorf
   carbamorph
   dimethomorph
   dodemorph
   fenpropimorph
   flumorph
   tridemorph
   organophosphorus fungicides
   ampropylfos
   ditalimfos
   edifenphos
   fosetyl
   hexylthiofos
   iprobenfos
   phosdiphen
   pyrazophos
   tolclofos-methyl
   triamiphos
   organotin fungicides
   decafentin
   fentin
   tributyltin oxide
   oxathiin fungicides
   carboxin
   oxycarboxin
   oxazole fungicides
   chlozolinate
   dichlozoline
   drazoxolon
   famoxadone
   hymexazol
   metazoxolon
   myclozolin
   oxadixyl
   vinclozolin
   polysulfide fungicides
   barium polysulfide
   calcium polysulfide
   potassium polysulfide
   sodium polysulfide
   pyrazole fungicides
   furametpyr
   penthiopyrad
   pyridine fungicides
   boscalid
   buthiobate
   dipyrithione
   fluazinam
   fluopicolide
   pyridinitril
   pyrifenox
   pyroxychlor
   pyroxyfur
   pyrimidine fungicides
   bupirimate
   cyprodinil
   diflumetorim
   dimethirimol
   ethirimol
   fenarimol
   ferimzone
   mepanipyrim
   nuarimol
   pyrimethanil
   triarimol
   pyrrole fungicides
   fenpiclonil
   fludioxonil
   fluoroimide
   quinoline fungicides
   ethoxyquin
   halacrinate
   8-hydroxyquinoline sulfate
   quinacetol
   30 quinoxyfen
   quinone fungicides
   benquinox
   chloranil
   dichione
   dithianon
   quinoxaline fungicides
   chinomethionat
   chlorquinox
   thioquinox
   thiazole fungicides
   ethaboxam
   etridiazole
   metsulfovax
   octhilinone
   thiabendazole
   thiadifluor
   thifluzamide
   thiocarbamate fungicides
   methasulfocarb
   prothiocarb
   thiophene fungicides
   ethaboxam
   silthiofam
   triazine fungicides
   anilazine
   triazole fungicides
   bitertanol
   fluotrimazole
   triazbutil
   see also conazole fungicides (triazoles)
   urea fungicides
   bentaluron
   pencycuron
   quinazamid
   unclassified fungicides
   acibenzolar
   acypetacs
   allyl alcohol
   benzalkonium chloride
   benzamacril
   bethoxazin
   carvone
   chloropicrin
   DBCP
   dehydroacetic acid
   diclomezine
   diethyl pyrocarbonate
   fenaminosulf
   fenitropan
   fenpropidin
   formaldehyde
   furfural
   hexachlorobutadiene
   iodomethane
   isoprothiolane
   methyl bromide
   methyl isothiocyanate
   metrafenone
   nitrostyrene
   nitrothal-isopropyl
   OCH
   2-phenylphenol
   phthalide
   piperalin
   probenazole
   proquinazid
   pyroquilon
   sodium orthophenylphenoxide
   spiroxamine
   sultropen
   thicyofen
   tricyclazole
   zinc naphthenate
Examples Herbicide Safeners:
benoxacor
cloquintocet
cyometrinil
dichlormid
dicyclonon
dietholate
fenchlorazole
fenclorim
flurazole
fluxofenim
furilazole
isoxadifen
mefenpyr
mephenate
naphthalic anhydride
oxabetrinil
   Examples of Herbicides
   amide herbicides
   allidochlor
   beflubutamid
   benzadox
   benzipram
   bromobutide
   cafenstrole
   CDEA
   chlorthiamid
   cyprazole
   dimethenamid
   dimethenamid-P
   diphenamid
   epronaz
   etnipromid
   fentrazamide
   flupoxam
   fomesafen
   halosafen
   isocarbamid
   isoxaben
   napropamide
   naptalam
   penoxsulam
   pethoxamid
   propyzamide
   quinonamid
   tebutam
      anilide herbicides
      chloranocryl
      cisanilide
      clomeprop
      cypromid
      diflufenican
      etobenzanid
      fenasulam
      flufenacet
      flufenican
      mefenacet
      mefluidide
      metamifop
      monalide
      naproanilide
      pentanochlor
      picolinafen
      propanil
         arylalanine herbicides
         benzoylprop
         flamprop
         flamprop-M
         chloroacetanilide herbicides
         acetochlor
         alachlor
         butachlor
         butenachlor
         delachlor
         diethatyl
         dimethachlor
         metazachlor
         metolachlor
         S-metolachlor
         pretilachlor
         propachlor
         propisochlor
         prynachlor
         terbuchlor
         thenylchlor
         xylachlor
         sulfonanilide herbicides
         benzofluor
         cloransulam
         diclosulam
         florasulam
         flumetsulam
         metosulam
         perfluidone
         profluazol
   antibiotic herbicides
   bilanafos
   aromatic acid herbicides
      benzoic acid herbicides
      chloramben
      dicamba
      2,3,6-TBA
      tricamba
         pyrimidinyloxybenzoic acid herbicides
         bispyribac
         pyriminobac
         pyrimidinylthiobenzoic acid herbicides
         pyrithiobac
      phthalic acid herbicides
      chlorthal
      picolinic acid herbicides
      aminopyralid
      clopyralid
      picloram
      quinolinecarboxylic acid herbicides
      quinclorac
      quinmerac
   arsenical herbicides
   cacodylic acid
   CMA
   DSMA
   hexaflurate
   MAA
   MAMA
   MSMA
   potassium arsenite
   sodium arsenite
   benzoylcyclohexanedione herbicides
   mesotrione
   sulcotrione
   benzofuranyl alkylsulfonate herbicides
   benfuresate
   ethofumesate
   carbamate herbicides
   asulam
   carboxazole
   chlorprocarb
   dichlormate
   fenasulam
   karbutilate
   terbucarb
   carbanilate herbicides
   barban
   BCPC
   carbasulam
   carbetamide
   CEPC
   chlorbufam
   chlorpropham
   CPPC
   desmedipham
   phenisopham
   phenmedipham
   phenmedipham-ethyl
   propham
   swep
   cyclohexene oxime herbicides
   alloxydim
   butroxydim
   clethodim
   cloproxydim
   cycloxydim
   profoxydim
   sethoxydim
   tepraloxydim
   tralkoxydim
   cyclopropylisoxazole herbicides
   isoxachlortole
   isoxaflutole
   dicarboximide herbicides
   benzfendizone
   cinidon-ethyl
   flumezin
   flumiclorac
   flumioxazin
   flumipropyn
   dinitroaniline herbicides
   benfluralin
   butralin
   dinitramine
   ethalfluralin
   fluchloralin
   isopropalin
   methalpropalin
   nitralin
   oryzalin
   pendimethalin
   prodiamine
   profluralin
   trifluralin
   dinitrophenol herbicides
   dinofenate
   dinoprop
   dinosam
   dinoseb
   dinoterb
   DNOC
   etinofen
   medinoterb
   diphenyl ether herbicides
   ethoxyfen
      nitrophenyl ether herbicides
      acifluorfen
      aclonifen
      bifenox
      chlomethoxyfen
      chlomitrofen
      etnipromid
      fluorodifen
      fluoroglycofen
      fluoronitrofen
      fomesafen
      furyloxyfen
      halosafen
      lactofen
      nitrofen
      nitrofluorfen
      oxyfluorfen
   dithiocarbamate herbicides
   dazomet
   metam
   halogenated aliphatic herbicides
   alorac
   chloropon
   dalapon
   flupropanate
   hexachloroacetone
   iodomethane
   methyl bromide
   monochloroacetic acid
   SMA
   TCA
   imidazolinone herbicides
   imazamethabenz
   imazamox
   imazapic
   imazapyr
   imazaquin
   imazethapyr
   inorganic herbicides
   ammonium sulfamate
   borax
   calcium chlorate
   copper sulfate
   ferrous sulfate
   potassium azide
   potassium cyanate
   sodium azide
   sodium chlorate
   sulfuric acid
   nitrite herbicides
   bromobonil
   bromoxynil
   chloroxynil
   dichlobenil
   iodobonil
   ioxynil
   pyraclonil
   organophosphorus herbicides
   amiprofos-methyl
   anilofos
   bensulide
   bilanafos
   butamifos
   2,4-DEP
   DMPA
   EBEP
   fosamine
   glufosinate
   glyphosate
   piperophos
   phenoxy herbicides
   bromofenoxim
   clomeprop
   2,4-DEB
   2,4-DEP
   difenopenten
   disul
   erbon
   etnipromid
   fenteracol
   trifopsime
      phenoxyacetic herbicides
      4-CPA
      2,4-D
      3,4-DA
      MCPA
      MCPA-thioethyl
      2,4,5-T
      phenoxybutyric herbicides
      4-CPB
      2,4-DB
      3,4-DB
      MCPB
      2,4,5-TB
      phenoxypropionic herbicides
      cloprop
      4-CPP
      dichlorprop
      dichlorprop-P
      3,4-DP
      fenoprop
      mecoprop
      mecoprop-P
         aryloxyphenoxypropionic herbicides
         chlorazifop
         clodinafop
         clofop
         cyhalofop
         diclofop
         fenoxaprop
         fenoxaprop-P
         fenthiaprop
         fluazifop
         fluazifop-P
         haloxyfop
         haloxyfop-P
         isoxapyrifop
         metamifop
         propaquizafop
         quizalofop
         quizalofop-P
         trifop
   phenylenediamine herbicides
   dinitramine
   prodiamine
   pyrazolyloxyacetophenone herbicides
   benzofenap
   pyrazoxyfen
   pyrazolylphenyl herbicides
   fluazolate
   pyraflufen
   pyridazine herbicides
   credazine
   pyridafol
   pyridate
   pyridazinone herbicides
   brompyrazon
   chloridazon
   dimidazon
   flufenpyr
   metflurazon
   norflurazon
   oxapyrazon
   pydanon
   pyridine herbicides
   aminopyralid
   cliodinate
   clopyralid
   dithiopyr
   fluroxypyr
   haloxydine
   picloram
   picolinafen
   pyriclor
   thiazopyr
   triclopyr
   pyrimidinediamine herbicides
   iprymidam
   tioclorim
   quaternary ammonium herbicides
   cyperquat
   diethamquat
   difenzoquat
   diquat
   morfamquat
   paraquat
   thiocarbamate herbicides
   butylate
   cycloate
   di-allate
   EPTC
   esprocarb
   ethiolate
   isopolinate
   methiobencarb
   molinate
   orbencarb
   pebulate
   prosulfocarb
   pyributicarb
   sulfallate
   thiobencarb
   tiocarbazil
   tri-allate
   vernolate
   thiocarbonate herbicides
   dimexano
   EXD
   proxan
   thiourea herbicides
   methiuron
   triazine herbicides
   dipropetryn
   triaziflam
   trihydroxytriazine
      chlorotriazine herbicides
      atrazine
      chlorazine
      cyanazine
      cyprazine
      eglinazine
      ipazine
      mesoprazine
      procyazine
      proglinazine
      propazine
      sebuthylazine
      simazine
      terbuthylazine
      trietazine
      methoxytriazine herbicides
      atraton
      methometon
      prometon
      secbumeton
      simeton
      terbumeton
      methylthiotriazine herbicides
      ametryn
      aziprotryne
      cyanatryn
      desmetryn
      dimethametryn
      methoprotryne
      prometryn
      simetryn
      terbutryn
   triazinone herbicides
   ametridione
   amibuzin
   hexazinone
   isomethiozin
   metamitron
   metribuzin
   triazole herbicides
   amitrole
   cafenstrole
   epronaz
   flupoxam
   triazolone herbicides
   amicarbazone
   carfentrazone
   flucarbazone
   propoxycarbazone
   sulfentrazone
   triazolopyrimidine herbicides
   cloransulam
   diclosulam
   florasulam
   flumetsulam
   metosulam
   penoxsulam
   uracil herbicides
   butafenacil
   bromacil
   flupropacil
   isocil
   lenacil
   terbacil
   urea herbicides
   benzthiazuron
   cumyluron
   cycluron
   dichloralurea
   diflufenzopyr
   isonoruron
   isouron
   methabenzthiazuron
   monisouron
   noruron
      phenylurea herbicides
      anisuron
      buturon
      chlorbromuron
      chloreturon
      chlorotoluron
      chloroxuron
      daimuron
      difenoxuron
      dimefuron
      diuron
      fenuron
      fluometuron
      fluothiuron
      isoproturon
      linuron
      methiuron
      methyldymron
      metobenzuron
      metobromuron
      metoxuron
      monolinuron
      monuron
      neburon
      parafluron
      phenobenzuron
      siduron
      tetrafluron
      thidiazuron
      sulfonylurea herbicides
         pyrimidinylsulfonylurea herbicides
         amidosulfuron
         azimsulfuron
         bensulfuron
         chlorimuron
         cyclosulfamuron
         ethoxysulfuron
         flazasulfuron
         flucetosulfuron
         flupyrsulfuron
         foramsulfuron
         halosulfuron
         imazosulfuron
         mesosulfuron
         nicosulfuron
         oxasulfuron
         primisulfuron
         pyrazosulfuron
         rimsulfuron
         sulfometuron
         sulfosulfuron
         trifloxysulfuron
         triazinylsulfonylurea herbicides
         chlorsulfuron
         cinosulfuron
         ethametsulfuron
         iodosulfuron
         metsulfuron
         prosulfuron
         thifensulfuron
         triasulfuron
         tribenuron
         triflusulfuron
         tritosulfuron
      thiadiazolylurea herbicides
      buthiuron
      ethidimuron
      tebuthiuron
      thiazafluron
      thidiazuron
   unclassified herbicides
   acrolein
   allyl alcohol
   azafenidin
   benazolin
   bentazone
   benzobicyclon
   buthidazole
   calcium cyanamide
   cambendichlor
   chlorfenac
   chlorfenprop
   chlorflurazole
   chlorflurenol
   cinmethylin
   clomazone
   CPMF
   cresol
   ortho-dichlorobenzene
   dimepiperate
   endothal
   fluoromidine
   fluridone
   flurochloridone
   flurtamone
   fluthiacet
   indanofan
   methazole
   methyl isothiocyanate
   nipyraclofen
   OCH
   oxadiargyl
   oxadiazon
   oxaziclomefone
   pentachlorophenol
   pentoxazone
   phenylmercury acetate
   pinoxaden
   prosulfalin
   pyrazolynate
   pyribenzoxim
   pyriftalid
   quinoclamine
   rhodethanil
   sulglycapin
   thidiazimin
   tridiphane
   trimeturon
   tripropindan
   tritac
      List of Insect Attractants:
brevicomin
codlelure
cue-lure
disparlure
dominicalure
eugenol
frontalin
gossyplure
grandlure
hexalure
ipsdienol
ipsenol
japonilure
lineatin
litlure
looplure
medlure
megatomoic acid
methyl eugenol
α-multistriatin
muscalure
orfralure
oryctalure
ostramone
siglure
sulcatol
trimedlure
trunc-call
   Insect Repellents
butopyronoxyl
dibutyl phthalate
diethyltoluamide
dimethyl carbate
dimethyl phthalate
ethohexadiol
hexamide
methoquin-butyl
methylneodecanamide
oxamate
picaridin
   Example of Insecticides
   antibiotic insecticides
   allosamidin
   thuringiensin
      macrocyclic lactone insecticides
      spinosad
         avermectin insecticides
         abamectin
         doramectin
         emamectin
         eprinomectin
         ivermectin
         selamectin
         milbemycin insecticides
         milbemectin
         milbemycin oxime
         moxidectin
   arsenical insecticides
   calcium arsenate
   copper acetoarsenite
   copper arsenate
   lead arsenate
   potassium arsenite
   sodium arsenite
   botanical insecticides
   anabasine
   azadirachtin
   d-limonene
   nicotine
   pyrethrins
   cinerins
   cinerin I
   cinerin II
   jasmolin I
   jasmolin II
   pyrethrin I
   pyrethrin II
   quassia
   rotenone
   ryania
   sabadilla
   carbamate insecticides
   bendiocarb
   carbaryl
      benzofuranyl methylcarbamate insecticides
      benfuracarb
      carbofuran
      carbosulfan
      decarbofuran
      furathiocarb
      dimethylcarbamate insecticides
      dimetan
      dimetilan
      hyquincarb
      pirimicarb
      oxime carbamate insecticides
      alanycarb
      aldicarb
      aldoxycarb
      butocarboxim
      butoxycarboxim
      methomyl
      nitrilacarb
      oxamyl
      tazimcarb
      thiocarboxime
      thiodicarb
      thiofanox
      phenyl methylcarbamate insecticides
      allyxycarb
      aminocarb
      bufencarb
      butacarb
      carbanolate
      cloethocarb
      dicresyl
      dioxacarb
      EMPC
      ethiofencarb
      fenethacarb
      fenobucarb
      isoprocarb
      methiocarb
      metolcarb
      mexacarbate
      promacyl
      promecarb
      propoxur
      trimethacarb
      XMC
      xylylcarb
   dinitrophenol insecticides
   dinex
   dinoprop
   dinosam
   DNOC
   fluorine insecticides
   barium hexafluorosilicate
   cryolite
   sodium fluoride
   sodium hexafluorosilicate
   sulfluramid
   formamidine insecticides
   amitraz
   chlordimeform
   formetanate
   formparanate
   fumigant insecticides
   acrylonitrile
   carbon disulfide
   carbon tetrachloride
   chloroform
   chloropicrin
   para-dichlorobenzene
   1,2-dichloropropane
   ethyl formate
   ethylene dibromide
   ethylene dichloride
   ethylene oxide
   hydrogen cyanide
   iodomethane
   methyl bromide
   methylchloroform
   methylene chloride
   naphthalene
   phosphine
   sulfuryl fluoride
   tetrachloroethane
   inorganic insecticides
   borax
   calcium polysulfide
   copper oleate
   mercurous chloride
   potassium thiocyanate
   sodium thiocyanate
   see also arsenical insecticides
   see also fluorine insecticides
   insect growth regulators
      chitin synthesis inhibitors
      bistrifluron
      buprofezin
      chlorfluazuron
      cyromazine
      diflubenzuron
      flucycloxuron
      flufenoxuron
      hexaflumuron
      lufenuron
      novaluron
      noviflumuron
      penfluron
      teflubenzuron
      triflumuron
      juvenile hormone mimics
      epofenonane
      fenoxycarb
      hydroprene
      kinoprene
      methoprene
      pyriproxyfen
      triprene
      juvenile hormones
      juvenile hormone I
      juvenile hormone II
      juvenile hormone III
      moulting hormone agonists
      chromafenozide
      halofenozide
      methoxyfenozide
      tebufenozide
      moulting hormones
      α-ecdysone
      ecdysterone
      moulting inhibitors
      diofenolan
      precocenes
      precocene I
      precocene II
      precocene III
      unclassified insect growth regulators
      dicyclanil
   nereistoxin analogue insecticides
   bensultap
   cartap
   thiocyclam
   thiosultap
   nicotinoid insecticides
   flonicamid
      nitroguanidine insecticides
      clothianidin
      dinotefuran
      imidacloprid
      thiamethoxam
      nitromethylene insecticides
      nitenpyram
      nithiazine
      pyridylmethylamine insecticides
      acetamiprid
      imidacloprid
      nitenpyram
      thiacloprid
   organochlorine insecticides
   bromo-DDT
   camphechlor
   DDT
   pp′-DDT
   ethyl-DDD
   HCH
   gamma-HCH
   lindane
   methoxychlor
   pentachlorophenol
   TDE
      cyclodiene insecticides
      aldrin
      bromocyclen
      chlorbicyclen
      chlordane
      chlordecone
      dieldrin
      dilor
      endosulfan
      endrin
      HEOD
      heptachlor
      HHDN
      isobenzan
      isodrin
      kelevan
      mirex
   organophosphorus insecticides
      organophosphate insecticides
      bromfenvinfos
      chlorfenvinphos
      crotoxyphos
      dichlorvos
      dicrotophos
      dimethylvinphos
      fospirate
      heptenophos
      methocrotophos
      mevinphos
      monocrotophos
      naled
      naftalofos
      phosphamidon
      propaphos
      schradan
      TEPP
      tetrachlorvinphos
      organothiophosphate insecticides
      dioxabenzofos
      fosmethilan
      phenthoate
         aliphatic organothiophosphate insecticides
         acethion
         amiton
         cadusafos
         chlorethoxyfos
         chlormephos
         demephion
         demephion-O
         demephion-S
         demeton
         demeton-O
         demeton-S
         demeton-methyl
         demeton-O-methyl
         demeton-S-methyl
         demeton-S-methylsulphon
         disulfoton
         ethion
         ethoprophos
         IPSP
         isothioate
         malathion
         methacrifos
         oxydemeton-methyl
         oxydeprofos
         oxydisulfoton
         phorate
         sulfotep
         terbufos
         thiometon
            aliphatic amide organothiophosphate insecticides
            amidithion
            cyanthoate
            dimethoate
            ethoate-methyl
            formothion
            mecarbam
            omethoate
            prothoate
            sophamide
            vamidothion
            oxime organothiophosphate insecticides
            chlorphoxim
            phoxim
            phoxim-methyl
         heterocyclic organothiophosphate insecticides
         azamethiphos
         coumaphos
         coumithoate
         dioxathion
         endothion
         menazon
         morphothion
         phosalone
         pyraclofos
         pyridaphenthion
         quinothion
            benzothiopyran organothiophosphate insecticides
            dithicrofos
            thicrofos
            benzotriazine organothiophosphate insecticides
            azinphos-ethyl
            azinphos-methyl
            isoindole organothiophosphate insecticides
            dialifos
            phosmet
            isoxazole organothiophosphate insecticides
            isoxathion
            zolaprofos
            pyrazolopyrimidine organothiophosphate insecticides
            chlorprazophos
            pyrazophos
            pyridine organothiophosphate insecticides
            chlorpyrifos
            chlorpyrifos-methyl
            pyrimidine organothiophosphate insecticides
            butathiofos
            diazinon
            etrimfos
            lirimfos
            pirimiphos-ethyl
            pirimiphos-methyl
            primidophos
            pyrimitate
            tebupirimfos
            quinoxaline organothiophosphate insecticides
            quinalphos
            quinalphos-methyl
            thiadiazole organothiophosphate insecticides
            athidathion
            lythidathion
            methidathion
            prothidathion
            triazole organothiophosphate insecticides
            isazofos
            triazophos
         phenyl organothiophosphate insecticides
         azothoate
         bromophos
         bromophos-ethyl
         carbophenothion
         chlorthiophos
         cyanophos
         cythioate
         dicapthon
         dichlofenthion
         etaphos
         famphur
         fenchlorphos
         fenitrothion
         fensulfothion
         fenthion
         fenthion-ethyl
         heterophos
         jodfenphos
         mesulfenfos
         parathion
         parathion-methyl
         phenkapton
         phosnichlor
         profenofos
         prothiofos
         suiprofos
         temephos
         trichlormetaphos-3
         trifenofos
      phosphonate insecticides
      butonate
      trichlorfon
      phosphonothioate insecticides
      mecarphon
         phenyl ethylphosphonothioate insecticides
         fonofos
         trichloronat
         phenyl phenylphosphonothioate insecticides
         cyanofenphos
         EPN
         leptophos
      phosphoramidate insecticides
      crufomate
      fenamiphos
      fosthietan
      mephosfolan
      phosfolan
      pirimetaphos
      phosphoramidothioate insecticides
      acephate
      isocarbophos
      isofenphos
      methamidophos
      propetamphos
      phosphorodiamide insecticides
      dimefox
      mazidox
      mipafox
   oxadiazine insecticides
   indoxacarb phthalimide insecticides
   dialifos
   phosmet
   tetramethrin
   pyrazole insecticides
   acetoprole
   ethiprole
   fipronil
   tebufenpyrad
   tolfenpyrad
   vaniliprole
   pyrethroid insecticides
      pyrethroid ester insecticides
      acrinathrin
      allethrin
      bioallethrin
      barthrin
      bifenthrin
      bioethanomethrin
      cyclethrin
      cycloprothrin
      cyfluthrin
      beta-cyfluthrin
      cyhalothrin
      gamma-cyhalothrin
      lambda-cyhalothrin
      cypermethrin
      alpha-cypermethrin
      beta-cypermethrin
      theta-cypermethrin
      zeta-cypermethrin
      cyphenothrin
      deltamethrin
      dimefluthrin
      dimethrin
      empenthrin
      fenfluthrin
      fenpirithrin
      fenpropathrin
      fenvalerate
      esfenvalerate
      flucythrinate
      fluvalinate
      tau-fluvalinate
      furethrin
      imiprothrin
      metofluthrin
      permethrin
      biopermethrin
      transpermethrin
      phenothrin
      prallethrin
      profluthrin
      pyresmethrin
      resmethrin
      bioresmethrin
      cismethrin
      tefluthrin
      terallethrin
      tetramethrin
      tralomethrin
      transfluthrin
      pyrethroid ether insecticides
      etofenprox
      flufenprox
      halfenprox
      protrifenbute
      silafluofen
   pyrimidinamine insecticides
   flufenerim
   pyrimidifen
   pyrrole insecticides
   chlorfenapyr
   tetronic acid insecticides
   spiromesifen
   thiourea insecticides
   diafenthiuron
   urea insecticides
   flucofuron
   sulcofuron
   see also chitin synthesis inhibitors
   unclassified insecticides
   closantel
   crotamiton
   EXD
   fenazaflor
   fenoxacrim
   hydramethylnon
   isoprothiolane
   malonoben
   metoxadiazone
   nifluridide
   pyridaben
   pyridalyl
   rafoxanide
   triarathene
   triazamate
      List of Mammal Repellents
copper naphthenate
trimethacarb
zinc naphthenate
ziram
   Mating Disrupters
disparlure
gossyplure
grandlure
   List of Molluscicides
bromoacetamide
calcium arsenate
cloethocarb
copper acetoarsenite
copper sulfate
fentin
metaldehyde
methiocarb
niclosamide
pentachlorophenol
sodium pentachlorophenoxide
tazimcarb
thiodicarb
tributyltin oxide
trifenmorph
trimethacarb
   Examples of Nematicides
   antibiotic nematicides
   abamectin
   carbamate nematicides
   benomyl
   carbofuran
   carbosulfan
   cloethocarb
      oxime carbamate nematicides
      alanycarb
      aldicarb
      aldoxycarb
      oxamyl
   organophosphorus nematicides
      organophosphate nematicides
      diamidafos
      fenamiphos
      fosthietan
      phosphamidon
      organothiophosphate nematicides
      cadusafos
      chlorpyrifos
      dichlofenthion
      dimethoate
      ethoprophos
      fensulfothion
      fosthiazate
      heterophos
      isamidofos
      isazofos
      mecarphon
      phorate
      phosphocarb
      terbufos
      thionazin
      triazophos
   unclassified nematicides
   acetoprole
   benclothiaz
   chloropicrin
   dazomet
   DBCP
   DCIP
   1,2-dichloropropane
   1,3-dichloropropene
   furfural
   iodomethane
   metam
   methyl bromide
   methyl isothiocyanate
   xylenols
      Examples of Plant Activators
acibenzolar
probenazole
   Examples of Plant Growth Regulators
   antiauxins
   clofibric acid
   2,3,5-tri-iodobenzoic acid
   auxins
   4-CPA
   2,4-D
   2,4-DB
   2,4-DEP
   dichlorprop
   fenoprop
   IAA
   IBA
   naphthaleneacetamide
   α-naphthaleneacetic acid
   1-naphthol
   naphthoxyacetic acid
   potassium naphthenate
   sodium naphthenate
   2,4,5-T
   cytokinins
   2iP
   benzyladenine
   kinetin
   zeatin
   defoliants
   calcium cyanamide
   dimethipin
   endothal
   ethephon
   metoxuron
   pentachlorophenol
   thidiazuron
   tribufos
   ethylene inhibitors
   aviglycine
   1-methylcyclopropene
   ethylene releasers
   ACC
   etacelasil
   ethephon
   glyoxime
   gibberellins
   gibberellins
   gibberellic acid
   growth inhibitors
   abscisic acid
   ancymidol
   butralin
   carbaryl
   chlorphonium
   chlorpropham
   dikegulac
   flumetralin
   fluoridamid
   fosamine
   glyphosine
   isopyrimol
   jasmonic acid
   maleic hydrazide
   mepiquat
   piproctanyl
   prohydrojasmon
   propham
   2,3,5-tri-iodobenzoic acid
      morphactins
      chlorfluren
      chlorflurenol
      dichlorflurenol
      flurenol
   growth retardants
   chlormequat
   daminozide
   flurprimidol
   mefluidide
   paclobutrazol
   tetcyclacis
   uniconazole
   growth stimulators
   brassinolide
   forchlorfenuron
   hymexazol
   unclassified plant growth regulators
   benzofluor
   buminafos
   carvone
   ciobutide
   clofencet
   cloxyfonac
   cyclanilide
   cycloheximide
   epocholeone
   ethychlozate
   ethylene
   fenridazon
   heptopargil
   holosulf
   inabenfide
   karetazan
   lead arsenate
   methasulfocarb
   prohexadione
   pydanon
   sintofen
   triapenthenol
   trinexapac
      Examples of Rodenticides
   botanical rodenticides
   scilliroside
   strychnine
   coumarin rodenticides
   brodifacoum
   bromadiolone
   coumachlor
   coumafuryl
   coumatetralyl
   difenacoum
   difethialone
   flocoumafen
   warfarin
   indandione rodenticides
   chlorophacinone
   diphacinone
   pindone
   inorganic rodenticides
   arsenous oxide
   phosphorus
   potassium arsenite
   sodium arsenite
   thallium sulfate
   zinc phosphide
   organochlorine rodenticides
   gamma-HCH
   HCH
   lindane
   organophosphorus rodenticides
   phosacetim
   pyrimidinamine rodenticides
   crimidine
   thiourea rodenticides
   antu
   urea rodenticides
   pyrinuron
   unclassified rodenticides
   bromethalin
   chloralose
   α-chlorohydrin
   ergocalciferol
   fluoroacetamide
   flupropadine
   hydrogen cyanide
   norbormide
   sodium fluoroacetate
      Examples of Pesticide Synergists
piperonyl butoxide
piprotal
propyl isome
sesamex
sesamolin
sulfoxide
   Examples of Virucides
imanin
ribavirin

According to a preferred feature of the present invention, the oxalate compound is administered against insects of the following orders:
Coleoptera—This is the largest order of insects. They have biting mouthparts and hard forewings.
Collembola—Small insects with no wings and long legs used for jumping. Most live in soil.
Dermaptera—Insects with biting mouthparts and long antennae. Most live in rotting plants.
Dictyoptera—Insects that lay their eggs in enclosed capsules called oothecae.
Diptera—Insects with 2 wings and compound eyes. Their mouthparts may be the sucking kind or the sponge-like absorbing kind.
Ephemeroptera—The most primitive winged insect. They have short antennae. Their nymphs live in fast-flowing water.
Hemiptera—Insects with unusual heads. The head has a snout used for piercing and sucking. The wings are usually hard and held flat against the body. The bottom portion of their wings near their body is leathery, and the tip of their wings is membranous.
Homoptera—Insects with piercing/sucking mouthparts. Their wings are membranous from base to tip. These insects feed exclusively on plants.
Hymenoptera—Insects with 4 wings, long legs, and compound eyes. Their mouthparts may be sponging, sucking, or biting.
Isoptera—The name Isoptera comes from the latin iso which means equal because both the front and hind wings of these insects are about the same size.
Lepidoptera—The name comes from lipido which means scale. The wings of these insects are covered by small, overlapping and often colorful scales. Most have sucking mouthparts.

Neuroptera—Insects with large, membranous wings with a dense network of veins.

Odonata—Insects with 2 pairs of wings and biting mouthparts. Most have thin legs and short antennae. Their heads are small, and their large compound eyes nearly cover their heads. Their nymphs live in water.

Orthoptera—These insects have a variety of shapes and characteristics. The one thing that they have in common is that they all move with great agility. Their wings fold over their body when not in use. Some of the females in some of the species in this class are wingless.

Plecoptera—Insects that are flat, with large wings and biting mouthparts. Their larvae live in water.

Protura—Primitive insects with no eyes, antennae, or wings. They live in soil.

Psocoptera—Small insects with long antennae and biting mouthparts.

Siphonaptera—Insects with long legs for jumping and sucking mouth parts.

Thysanura—Insects with soft, flat bodies. They are colorless. They are called bristletails and have short legs but move very rapidly.

Trichoptera—Insects with long antennae and legs. They have hairs on the surface of their wings.

In one of the embodiment of this invention, oxal ate is used in controlling insects that attack cotton such as, but not limited to, those insects that are listed below:

| | Common Name | Order | Host or Location |
|---|---|---|---|
| 1. | Water springtail | Collembola | Surface of puddles |
| 2. | Silverfish | Thysanura | Trunk, closet |
| 3. | Mayfly | Ephemeroptera | Near water |
| 4. | Green darner | Odonata | Stream |
| 5. | Black-winged | Odonata | Stream |
| | damselfly | | |
| 6. | Stonefly | Plecoptera | Near water |
| 7. | True katydid | Orthoptera | Trees |
| 8. | Carolina grasshopper | Orthoptera | Pasture |
| 9. | Snowy tree cricket | Orthoptera | Trees |
| 10. | Differential | Orthoptera | Pasture |
| | grasshopper | | |
| 11. | Long-horned | Orthoptera | Shrubs/grass |
| | grasshopper | | |
| 12. | Mole cricket | Orthoptera | Sandy soil |
| 13. | German cockroach | Blattaria | Home |
| 14. | American cockroach | Blattaria | Home |
| 15. | Praying mantids | Mantodea | Shrubs, vegetation |
| 16. | Walkingstick | Phasmida | Shrubs, vegetation |
| 17. | Earwig | Dermaptera | Ground trash |
| 18. | Subterranean termite | Isoptera | Wood, stumps |
| 19. | Booklouse | Psocoptera | Libraries, papers, |
| | | | books |
| 20. | Barklouse | Psocoptera | Tree trunk |
| 21. | Chicken head louse | Phthiraptera | Poultry |
| | | (Mallophaga) | |
| 22. | Short-nosed cattle | Phthiraptera | Cattle |
| | louse | (Anoplura) | |
| 23. | Human body louse | Phthiraptera | Humans |
| | | (Anoplura) | |
| 24. | Hog louse | Phthiraptera | Swine |
| | | (Anoplura) | |
| 25. | Cotton fleahopper | Hemiptera | Cotton |
| 26. | False chinch bug | Hemiptera | Grain sorghum |
| 27. | Large milkweed bug | Hemiptera | Milkweed |
| 28. | Ambush bug | Hemiptera | Flowers |
| 29. | Backswimmer | Hemiptera | Pond |
| 30. | Water striders | Hemiptera | Pond |
| 31. | Water scorpions | Hemiptera | Stream |
| 32. | Water boatman | Hemiptera | Pond |
| 33. | Toad bug | Hemiptera | Shoreline |
| 34. | Green stink bug | Hemiptera | Weeds |
| 35. | Harlequin bug | Hemiptera | Cole crops |
| 36. | Leaffooted bug | Hemiptera | Plants, weeds |
| 37. | Tarnished plant bug | Hemiptera | Plants, weeds |
| 38. | Squash bug | Hemiptera | Squash |
| 39. | Chinch bug | Hemiptera | Grass |
| 40. | Giant water bug | Hemiptera | Water, ponds |
| 41. | Western flower | Thysanoptera | Cotton |
| | thrips | | |
| 42. | Onion thrips | Thysanoptera | Onions |
| 43. | Leafhopper | Homoptera | Grasses |
| 44. | San Jose scale | Homoptera | Fruit trees |
| 45. | Greenbug | Homoptera | Small grain |
| 46. | Obscure scale | Homoptera | Pecans |
| 47. | Pecan phylloxera | Homoptera | Pecans |
| 48. | Buffalo treehopper | Homoptera | Trees |
| 49. | Spittlebug | Homoptera | Alfalfa |
| 50. | Corn leaf aphid | Homoptera | Corn, sorghum |
| 51. | Cicada | Homoptera | Trees |
| 52. | Mantispid | Neuroptera | Woodlots |
| 53. | Antlion | Neuroptera | Plants |
| 54. | Dobsonfly | Neuroptera | Stream |
| 55. | Green lacewing | Neuroptera | Alfalfa |
| 56. | Carpet beetle | Coleoptera | Wool carpets |
| 57. | Corn or rice weevil | Coleoptera | Stored grain |
| 58. | Pea weevil | Coleoptera | Stored grain |
| 59. | Confused flour | Coleoptera | Stored grain |
| | beetle | | |
| 60. | Flat grain beetle | Coleoptera | Stored grain |
| 61. | Lesser grain borer | Coleoptera | Stored grain |
| 62. | Sawtoothed grain | Coleoptera | Stored grain |
| | beetle | | |
| 63. | Alfalfa weevil | Coleoptera | Alfalfa |
| 64. | Striped blister beetle | Coleoptera | Plants, alfalfa, |
| | | | weeds |
| 65. | Flat-headed borer | Coleoptera | Trees |
| 66. | Plum curculio | Coleoptera | Peaches |
| 67. | Boll weevil | Coleoptera | Cotton |
| 68. | Tiger beetle | Coleoptera | Shady trails |
| 69. | Carrion beetle | Coleoptera | Dead animals |
| 70. | Carrot beetle | Coleoptera | Sunflowers |
| 71. | Colorado potato | Coleoptera | Potatoes |
| | beetle | | |
| 72. | Spotted cucumber | Coleoptera | Weeds |
| | beetle | | |
| 73. | Rhinoceros beetle | Coleoptera | Woodland |
| 74. | Firefly or | Coleoptera | Weeds |
| | lightningbug | | |
| 75. | May beetle or | Coleoptera | Shrubs |
| | junebug | | |
| 76. | Lady beetle | Coleoptera | Weeds |
| 77. | Old house borer | Coleoptera | Lumber |
| 78. | Sweet potato weevil | Coleoptera | Sweet potatoes |
| 79. | Flea beetle | Coleoptera | Weeds |
| 80. | Caterpillar hunter | Coleoptera | Woodland |
| 81. | Predaceous diving | Coleoptera | Ponds |
| | beetle | | |
| 82. | Water scavenger | Coleoptera | Stream |
| | beetle | | |
| 83. | Whirlygig beetle | Coleoptera | Stream |
| 84. | Unicorn beetle | Coleoptera | Woodland |
| 85. | Locust borer | Coleoptera | Black locust |
| 86. | Soldier beetle | Coleoptera | Flowers |
| 87. | Scorpionfly | Mecoptera | Plants |
| 88. | Caddisfly | Trichoptera | Near stream |
| 89. | Clothes moth | Lepidoptera | Stored woolens |
| 90. | Angoumois grain | Lepidoptera | Stored grain |
| | moth | | |
| 91. | Tomato hornworm | Lepidoptera | Tomatoes |
| 92. | Cabbage looper | Lepidoptera | General feeder |
| 93. | Bollworm or corn | Lepidoptera | Cotton, corn, other |
| | earworm | | crops |
| 94. | Variegated cutworm | Lepidoptera | General feeder |
| 95. | Peach tree borer | Lepidoptera | Peach trees |
| 96. | Fall webworm | Lepidoptera | Pecans |
| 97. | Pecan nut casebearer | Lepidoptera | Pecans |
| 98. | Cotton leafworm | Lepidoptera | Cotton |
| 99. | Armyworm | Lepidoptera | Grasses |
| 100. | Sorghum webworm | Lepidoptera | Grain sorghum |
| 101. | Pink bollworm | Lepidoptera | Cotton |
| 102. | Fall armyworm | Lepidoptera | Grasses |
| 103. | Viceroy | Lepidoptera | Poplar |
| 104. | Buckeye | Lepidoptera | Plantain |
| 105. | Mourningcloak | Lepidoptera | Willow |
| | butterfly | | |
| 106. | Cabbage butterfly | Lepidoptera | Cole crops |
| 107. | Cecropia | Lepidoptera | Oak |
| 108. | Bagworm | Lepidoptera | Juniper |
| 109. | Leopard moth | Lepidoptera | Weeds |
| 110. | Red admiral | Lepidoptera | Nettles |
| 111. | Question mark | Lepidoptera | Elms |
| 112. | Wood nymph | Lepidoptera | Thick woods |
| 113. | Gray hairstreak | Lepidoptera | Cotton |
| | (Cotton square | | |
| | borer) | | |
| 114. | Alfalfa caterpillar | Lepidoptera | Alfalfa |
| 115. | Giant swallowtail | Lepidoptera | Citrus |
| 116. | Black swallowtail | Lepidoptera | Carrots, weeds |
| 117. | Tiger swallowtail | Lepidoptera | Cherry |
| 118. | White-lined sphinx | Lepidoptera | Around lights |
| 119. | Salt-marsh | Lepidoptera | Grasses, weeds |
| | caterpillar | | |
| 120. | Polyphemus | Lepidoptera | Oaks |
| 121. | Io moth | Lepidoptera | Trees, corn |
| 122. | Underwing moths | Lepidoptera | Trees |
| 123. | Luna moth | Lepidoptera | Oak |
| 124. | Monarch | Lepidoptera | Milkweed |
| 125. | Eastern tent | Lepidoptera | Cherry, plum |
| | caterpillar | | |
| 126. | Silver-spotted | Lepidoptera | Black locust |
| | skipper | | |
| 127. | Carpenter moth | Lepidoptera | Trees |
| 128. | Greater wax moth | Lepidoptera | Beehive |
| 129. | Common cattle grub | Diptera | Cattle |
| 130. | Horn fly | Diptera | Cattle |
| 131. | Stable fly | Diptera | Cattle |
| 132. | Screwworm | Diptera | Cattle |
| 133. | Housefly | Diptera | Barn |
| 134. | Sorghum midge | Diptera | Grain sorghum |
| 135. | Bee fly | Diptera | Flowers |
| 136. | Syrphid fly(flower | Diptera | Flowers |
| | fly) | | |
| 137. | Fruit fly | Diptera | Ripe & rotten fruit |
| 138. | Mydas fly | Diptera | Woodlands |
| 139. | Buffalo gnat | Diptera | Stream |
| 140. | Crane fly | Diptera | Meadow |
| 141. | Horsefly | Diptera | Woodland |
| 142. | Deer fly | Diptera | Woodland |
| 143. | Mosquito | Diptera | Yard and meadow |
| 144. | Cat flea | Siphonaptera | Cat |
| 145. | Red harvester ant | Hymenoptera | Seed plants |
| 146. | Potter wasps | Hymenoptera | Building |
| 147. | Velvet ants | Hymenoptera | Soil |
| 148. | Cicada killer | Hymenoptera | Soil |
| 149. | Baldfaced hornet | Hymenoptera | Woodlands |
| 150. | Leafcutting bee | Hymenoptera | Flowers |
| 151. | Yellowjacket | Hymenoptera | House eaves |
| 152. | Horntail | Hymenoptera | Logs |
| 153. | Carpenter bee | Hymenoptera | Fence post |
| 154. | Honeybee | Hymenoptera | Flowers |
| 155. | Mud dauber | Hymenoptera | Buildings |
| 156. | Bumblebee | Hymenoptera | Meadow |
| 157. | Texas leafcutting ant | Hymenoptera | Woodlands |
| 158. | Lone star tick | Acari | Cattle |
| 159. | Fowl tick (blue bug) | Acari | Poultry |
| 160. | Black widow spider | Araneae | Woodlot |
| 161. | Brown recluse spider | Araneae | Homes |
| 162. | Trapdoor spider | Araneae | Soil |
| 163. | Black and yellow | Araneae | Garden |
| | argiope | | |
| 164. | Wolfspiders | Araneae | Under rocks |
| 165. | Crab spiders | Araneae | Flowers |
| 166. | Jumping spiders | Araneae | Garden |
| 167. | Scorpion | Scorpionida | Log pile |
| 168. | Sun spiders | Solpugida | Arid regions |
| 169. | Spider mite | Acarina | Plants |

According to a preferred feature of the present invention, the oxalate compound is administered against fungi of the orders that are listed in Chapter 10 (Plant diseases caused by Fungi) in Plant Pathology book authored by George N. Agrios. Academic Press. A list of these fungi orders are enclosed. The entire content of the book is incorporated herein by a reference.

According to a preferred feature of the present invention, the oxalate compound is administered against bacteria of the orders that are listed in Chapter 11 (Plant diseases caused by bacteria) in Plant Pathology book authored by George N. Agrios. Academic Press. A list of these bacterial orders are enclosed. The entire content of the book is incorporated herein by a reference.

According to a preferred feature of the present invention, the oxalate compound is administered against virus of the orders that are listed in Chapter 14 (Plant diseases caused by viruses) in Plant Pathology book authored by George N. Agrios. Academic Press. A list of these plant viruses are enclosed. The entire content of the book is incorporated herein by a reference.

According to a preferred feature of the present invention, the oxalate compound is administered against a nematode of the orders that are listed in Chapter 15 (Plant diseases caused by nematode) in Plant Pathology book authored by George N. Agrios. Academic Press. A list of various classes of plant-parasitic nematodes is enclosed. The entire content of the book is incorporated herein by a reference.

According to a preferred feature of the present invention, the oxalate compound is administered against mycoplasma and mycoplasmalike (Plant diseases caused by mycoplasma organisms).

According to a preferred feature of the present invention, the oxalate compound is administered to the plant or plant part alone or in the form of a composition.

According to a preferred feature of the present invention, oxalate compound may be applied alone to a plant, to a seed of a plant, to the locus of the plant or seed, to soil or to any other growth medium.

According to a preferred feature of the present invention, oxalate compound may be applied to a plant, to a seed of a plant, to the locus of the plant or seed, to soil or to any other growth medium, in a formulated composition which includes, in addition to the oxalate compound, another chemical such as a pesticide or any other chemical that is within the scope of the invention. In one aspect of the invention, the composition might also comprise a suitable inert diluent or carrier and, optionally, a surface active agent (SFA). SFAs are chemicals able to modify the properties of an interface (for example, liquid/solid, liquid/air or liquid/liquid interfaces) by lowering the interfacial tension and thereby leading to changes in other properties (for example dispersion, emulsification and wetting). It is preferred that all compositions (both solid and liquid formulations) comprise, by weight, 0.0001 to 95%, more preferably 1 to 85%, of an oxalate compound. The composition is applied at a rate of from 0.1 kg to 10 kg per hectare, preferably from 1 g to 6 kg per hectare, more preferably from 1 g to 1 kg per hectare.

When used in a seed dressing, the oxalate compound is used at a rate of 0.0001 g to 10 g (for example 0.001 g or 0.05 g), preferably 0.005 g to 10 g, more preferably 0.005 g to 4 g, per kilogram of seed.

The compositions can be chosen from a number of formulation types, including dustable powders (DP), soluble powders (SP), water soluble granules (SG), water dispersible granules (WG), wettable powders (WP), granules (GR) (slow or fast release), soluble concentrates (SL), oil miscible liquids (OL), ultra low volume liquids (UL), emulsifiable concentrates (EC), dispersible concentrates (DC), emulsions (both oil in water (EW) and water in oil (EO)), micro-emulsions (ME), suspension concentrates (SC), aerosols, fogging/smoke formulations, capsule suspensions (CS) and seed treatment formulations. The formulation type chosen in any instance will depend upon the particular purpose envisaged and the physical, chemical and biological properties of the anti-fungal compound.

The following are only a few examples where the invention will likely find application. It should be understood that my invention is not limited to these examples. Other important applications of my invention would be readily recognized by those of ordinary skills in the art. Other uses which are potentially recognizable by those of ordinary skills in the art are also part of my invention.

The prior art documents mentioned herein are incorporated to the fullest extent permitted by law.

Bioefficacy Assays

Boll Weevil Larvae Bioassay

Assays for activity against boll weevil larvae are carried out by incorporating the test sample into a agar liquid diet similar to that for southern corn rootworm [Marrone P. G., Ferri F. D., Mosley T. R., Meinke L. J., “Improvements in laboratory rearing of the southern corn rootworm, Diabrotica undecimpunctata howardi Barber (Coleoptera: Chrysomelidae) on artificial diet and corn,” Journal of Economic Entomology, 78:290-3, 1985]. The test sample is substituted for the 20% water component. Neonate larvae are allowed to feed on the diet and mortality and growth stunting are evaluated.

Lepidopteran Larvae Bioassay

Lepidopteran larvae are tested on artificial diet treated with various amounts of oxalate for a number of days.

Boll Weevil Reproduction Test

Oxalate, in addition to lethal effects on larvae, will also affect the reproductive cycle of adult boll weevils that is demonstrated by the following study.

Preoviposition: Approximately 220 adult boll weevils, collected within 2 days of emergence, are divided into two groups. One is fed standard diet and the other is fed standard diet containing various concentrations of oxalate from Sigma. The adults are allowed to feed and mate for four days at which time mortality is determined.

Oviposition study: These two groups of adults are then divided into two subgroups and individually placed on artificial, oxalate-containing or control bolls. Artificial bolls are constructed of standard diet, with or without oxalate, and encased in paraffin containing 1% cottonseed oil. After three days at 27% C, the adults are removed and ten bolls from each of the four groups are removed and examined for eggs. The remaining bolls are incubated for an additional 7 days at 27% C to allow development of larvae. The bolls are then dissected and the eggs and larvae, dead and surviving, are counted.
Group 1=Control Adults placed on control bolls
Group 2=Control Adults placed on treated bolls
Group 3=oxalate-fed adults placed on control bolls
Group 4=oxalate-fed adults placed on treated bolls
   Mode of Action Studies

The following studies are used to show that oxalate has a direct effect on the insect itself. Lepidopteran larvae and boll weevils are most susceptible to oxalate. Oxalic acid causes death in humans and animals due to its corrosive effects. In smaller amounts, oxalic acid causes a variety of pathological disorders, including hyperoxaluria, pyridoxine deficiency, cardiomyopathy, cardiac conductance disorders, calcium oxalate stones and renal failure.

Cotton Seed Diet Assay

Two treatment diets are made by mixing 30 g of one of two types of cottonseed flour into 170 mL of a 1.6% agar solution at 50% C, containing 0.13% propionic acid, 0.014% phosphoric acid, and 30 mg each of streptomycin sulfate and chlortetracycline. Before mixing, 10% KOH was used to adjust the pH to 6.2. One test diet utilized raw cottonseed flour (Sigma) as the nutrient source; the other utilized Pharmamedia.™. (Traders Protein), a flour made up of cottonseed embryos. The diets were incubated in a water bath at 40% C. Dilutions of the oxalate are incorporated into the diets as described above. Boll weevil larvae are allowed to feed and mortality rates are determined after six days. The results demonstrate that the enzyme is lethal to boll weevil larvae in the presence of cotton plant components.

Homogenized Cotton Leaf Tissue Assay

In order to test oxalate against boll weevil larvae in a host tissue diet environment, a study is conducted in which cotton leaf tissue is the only nutritional component of an agar-based diet. Two cotton leaves (each approx. 5 inches wide) with stems are homogenized at 50% C into 170 mL of a 1.6% agar solution containing 0.13% propionic acid, 0.014% phosphoric acid, and 30 mg each of streptomycin sulfate and chlortetracycline. Before addition of the leaves, 10% KOH is used to adjust the pH of the agar solution to 6.2. The leaf “diet” is allowed to cool to 40% C. Dilutions of oxalate and a water control are incorporated into the leaf “diet”, poured into insect diet trays and allowed to cool. Boll weevil eggs are added to the diet wells. The assay is evaluated six days later. The results will show that the oxalate maintains its insecticidal activity in the presence of cotton leaf tissue. This will illustrate that the oxalate is insecticidal in the presence of intact cotton tissue and cells.

Spectrum of Insecticidal Activity of Oxalate

Three other coleopteran species, three other insects, and one mite species are evaluated for susceptibility to oxalate. Bioassays are evaluated after 4 to 7 days to measure acute effects of the oxalate on the insects' growth and survival. Mortality or stunting of larval growth are observed in these short term assays.

Expression of Oxalate-Generating Enzyme in Plant Colonizing Bacteria

To control boll weevil, it may be desirable to express oxalate-generating enzyme in plant colonizing bacteria, and then apply this bacteria to the plant. As the boll weevil feeds on the plant, it ingests a toxic dose oxalate-generating enzyme produced by the plant colonizers. Plant colonizers can be either those that inhabit the plant surface, such as Pseudomonas or Agrobacterium species, or endophytes that inhabit the plant vasculature such as Clavibacter species. For surface colonizers, gene coding for oxalate-generating enzyme may be inserted into a broad host range vector capable of replicating in these Gram-negative hosts. Examples of these such vectors are pKT231 of the IncQ incompatibility group [Bagdasarian M., Lurz R., Ruckert B., Franklin F., Bagdasarian M. M., and Timmis K. N, “Specific purpose cloning vectors. II. Broad host range, high copy number RSF 1010-derived vectors and a host vector system for gene cloning in Pseudomonas,” Gene, 16:237-47, 1981. Bevan M et al., Nature, 304:184, 1983.] or pVK100 of the IncP group [Knauf V. C. and Nester E, “Wide host range cloning vectors: A cosmid bank of an Agrobacterium Ti plasmid,” Plasmid, 8:43-54, 1982.]. For endophytes the gene coding for oxalate-generating enzyme can be inserted into the chromosome by homologous recombination or by incorporation of the gene onto an appropriate transposon capable of chromosomal insertion in these endophytic bacteria.

Plant Gene Construction

The expression of a plant gene which exists in double-stranded DNA form involves transcription of messenger RNA (mRNA) from one strand of the DNA by RNA polymerase enzyme, and the subsequent processing of the mRNA primary transcript inside the nucleus. This processing involves a 3′ non-translated region which adds polyadenylate nucleotides to the 3′ end of the RNA. Transcription of DNA into mRNA is regulated by a region of DNA usually referred to as the “promoter.” The promoter region contains a sequence of bases that signals RNA polymerase to associate with the DNA and to initiate the transcription of mRNA using one of the DNA strands as a template to make a corresponding strand of RNA.

A number of promoters which are active in plant cells have been described in the literature. Such promoters may be obtained from plants or plant viruses and include, but are not limited to, the nopaline synthase (NOS) and octopine synthase (OCS) promoters (which are carried on tumor-inducing plasmids of Agrobacterium tumefaciens), the cauliflower mosaic virus (CaMV) 19S and 35S promoters, the light-inducible promoter from the small subunit of ribulose 1,5-bis-phos-phate carboxylase (ssRUBISCO, a very abundant plant polypeptide), and the Figwort Mosaic Virus (FMV) 35S promoter. All of these promoters have been used to create various types of DNA constructs which have been expressed in plants (see e.g., PCT publication WO 84/02913).

The particular promoter selected should be capable of causing sufficient expression of the enzyme coding sequence to result in the production of an effective amount of oxalate. A preferred promoter is a constitutive promoter such as FMV35S. It has been observed to provide more uniform expression of heterologous genes in the flowering portions of plants. Use of such a promoter with a gene coding for oxalate-producing gene enzyme provide greater protection of cotton bolls and squares from boll weevil damage, than other promoters.

The promoters used in the DNA constructs (i.e. chimeric plant genes) of the present invention may be modified, if desired, to affect their control characteristics. For example, the CaMV35S promoter may be ligated to the portion of the ssRUBISCO gene that represses the expression of ssRUBISCO in the absence of light, to create a promoter which is active in leaves but not in roots. The resulting chimeric promoter may be used as described herein. For purposes of this description, the phrase “CaMV35S” promoter thus includes variations of CaMV35S promoter, e.g., promoters derived by means of ligation with operator regions, random or controlled mutagenesis, etc. Furthermore, the promoters may be altered to contain multiple “enhancer sequences” to assist in elevating gene expression. Examples of such enhancer sequences have been reported by Kay et al. (Kay R. et al., Science, 236:1299-1302, 1987).

The RNA produced by a DNA construct of the present invention also contains a 5′ non-translated leader sequence. This sequence can be derived from the promoter selected to express the gene, and can be specifically modified so as to increase translation of the mRNA. The 5′ non-translated regions can also be obtained from viral RNA's, from suitable eukaryotic genes, or from a synthetic gene sequence. The present invention is not limited to constructs wherein the non-translated region is derived from the 5′ non-translated sequence that accompanies the promoter sequence. As shown below, a plant gene leader sequence which is useful in the present invention is the petunia heat shock protein 70 (Hsp70) leader. [Winter et al Mol Gen. Genet., 221(2):315-19, 1988.]

As noted above, the 3′ non-translated region of the chimeric plant genes of the present invention contains a polyadenylation signal which functions in plants to cause the addition of adenylate nucleotides to the 3′ end of the RNA. Examples of preferred 3′ regions are (1) the 3′ transcribed, non-translated regions containing the polyadenylate signal of Agrobacterium tumor-inducing (Ti) plasmid genes, such as the nopaline synthase (NOS) gene and (2) plant genes like the soybean 7s storage protein genes and the pea ssRUBISCO E9 gene. [Fischhoff D. A. and Perlak F. J., “Synthetic plant genes and method for preparation.” European Patent Application, Publication Number 0 385 962, 1990].

Plant Transformation and Expression

A chimeric plant gene containing a structural coding sequence of the present invention can be inserted into the genome of a cotton plant by any suitable method. Suitable plant transformation vectors include those derived from a Ti plasmid of Agrobacterium tumefaciens, as well as those disclosed, e.g., by Herrera-Estrella (Herrera-Estrella L. et al., Nature, 303:209, 1983), Bevan (Bevan M et al., Nature, 304:184, 1983), Klee (Klee H. J. et al., Bio/Technology, 3:637-642, 1985.) and EPO publication 0 120 516 (Schilperoort et al.). In addition to plant transformation vectors derived from the Ti or root-inducing (Ri) plasmids of Agrobacterium, alternative methods can be used to insert the DNA constructs of this invention into plant cells. Such methods may involve, for example, the use of liposomes, electroporation, chemicals that increase free DNA uptake, free DNA delivery via microprojectile bombardment, and transformation using viruses or pollen.

Unless otherwise defined, all technical and scientific terms used herein have the same meaning as commonly understood by one of ordinary skill in the art of molecular biology. Although methods and materials similar or equivalent to those described herein can be used in the practice or testing of the present invention, suitable methods and materials are described herein. All publications, patent applications, patents, and other references mentioned herein are incorporated by reference in their entirety. In case of conflict, the present specification, including definitions, will control. In addition, the materials, methods, and examples are illustrative only and are not intended to be limiting.

Reference is made to standard textbooks and other references (e.g., journal articles) that contain definitions and methods and means for carrying out basic techniques, encompassed by the present invention.

Equivalents

Those skilled in the art will recognize, or be able to ascertain using no more than routine experimentation, many equivalents to the specific embodiments of the invention described herein. Such equivalents are intended to be encompassed by the following claims.

What is claimed is:

1. A pesticidal composition which comprises, in variable quantities, an oxalate and a pesticidally active compound in free form or in the form of an agrochemically acceptable salt thereof.

2. A pesticidal composition which comprises, in variable quantities, an oxalate and a pesticidally active compound in free form or in the form of an agrochemically acceptable salt thereof, and at least one auxiliary or carrier material.

3. A pesticidal composition for treating infectious or pathogenic pest in a plant comprising:
a pesticidal composition including an effective amount of at least one effective pesticidal form of oxalate and at least one pesticide, wherein said effective amount is a lethal dosage of oxalate and wherein said pesticide composition is adapted to be administered to a plant on a periodic basis in a lethal dosage to a pest.

4. The pesticidal composition as recited in claim 3, wherein said effective pesticidal form of at least one of oxalate is selected from the group of oxalic acid in a free acid, ester, lactone and salt form.

5. The pesticidal composition as recited in claim 3, wherein said effective pesticidal form of oxalate is selected from the group of fungi, natural foods, for processed foods, beverages, liquids, and juices, containing at least one of oxalic acid and oxalate.

6. The pesticidal composition of claim 3, wherein the composition is at least a therapeutic quantity of oxalate from a natural source.

7. The pesticidal composition as recited in claim 3, wherein the said composition is oxalic acid dihydrate and the at least one carrier and/or diluent.

8. The pesticidal composition as recited in claim 3, wherein said at least one of carrier and/or diluent

9. A method of producing the therapeutic composition as recited in claim 3 comprising the steps of mixing a dilute concentration of at least one therapeutically effective form of oxalate with a solvent.

10. The method as recited in claim 9, wherein said therapeutically effective biocidal form of at least one of oxalic acid and oxalate is selected from the group of oxalic acid in a free acid, ester, lactone or salt form.

11. The pesticidal composition according to claim 3 wherein the pesticide further comprises a carrier.

12. The pesticidal composition according to claim 11 wherein the carrier is selected from the group consisting of: water, stabilizers, emulsifiers, oils, surfactants, antioxidants and UV screens.

13. The pesticidal composition according to claim 12 wherein the surfactant is a non-ionic surfactant.

14. The pesticidal composition according to claim 13 wherein the surfactant is a non-ionic organic surfactant.

15. The pesticidal composition according to claim 14 wherein the surfactant is nonylphenoxy polyethoxyethanol.

16. The pesticidal composition according to claim 12 wherein the pesticide comprises 0.01 to 0.1% surfactant.

17. The pesticidal composition according to claim 16 wherein the pesticide comprises about 0.03% (w/v) surfactant.

18. The pesticidal composition according to claim 3 wherein the plant is selected the group consisting of an ornamental plant, a fruit plant, an herb or a medicinal plant, a fruit plant, carnation, rose, lavender, tulip, delphinium, dahlia, citrus fruit tree, grape vine, strawberry, coffee, banana, tomato, rockmelon, watermelon plant, red clover, a vegetable plant, chamomile, aloe, evening primrose, skullcap, Echinacca, saw palmetto, feverfew, witch hazel, valerian, tea tree, garlic, eucalyptus, basil, parsley or ginseng plant.

19. The pesticidal composition according to claim 18 wherein the vegetable plant is a bean, corn, carrot, cucumber, potato, radish, spinach, pea, lettuce, onion, cabbage, broccoli, cauliflower, zucchini or turnip plant.

20. The pesticidal composition according to claim 3 wherein the plant is selected from the group consisting of a cereal plant, a turf grass plant and, a forage grass plant.
